(19) United States
(12) Patent Application Publication
(10) Pub. No.: US 2025/0199427 A1
(43) Pub. Date: Jun. 19, 2025

(54) TONER

(71) Applicant: CANON KABUSHIKI KAISHA, Tokyo (JP)

(72) Inventors: GAKU SATO, Chiba (JP); JUNICHI TAMURA, Ibaraki (JP); HAYATO IDA, Ibaraki (JP); TAKESHI HASHIMOTO, Ibaraki (JP)

(21) Appl. No.: 18/972,416

(22) Filed: Dec. 6, 2024

(30) Foreign Application Priority Data
Dec. 13, 2023 (JP) 2023-210572
Nov. 22, 2024 (JP) 2024-204019

(51) Int. Cl. G03G 9/087; G03G 9/08

(52) U.S. Cl. CPC G03G 9/08731; G03G 9/0819

(57) ABSTRACT

A toner is provided, which has a toner particle including a binder resin and inorganic fine particles, wherein the binder resin includes a crystalline vinyl resin having a specific monomer unit having at least two long-chain alkyl groups, the content of the specific monomer unit is at least 5.0% by mass, based on the mass of the crystalline vinyl resin, the inorganic fine particles each have on a surface thereof alkyl groups, and the content of the inorganic fine particles is 0.10% by mass to 15.00% by mass, based on the mass of the toner particle.

### BACKGROUND OF THE INVENTION

### Field of the Invention

The present disclosure relates to a toner used for an electrophotographic method, an electrostatic recording method, an electrostatic printing method, and a toner jet method.

### Description of the Related Art

The demand for delivering higher printing speeds and greater energy savings has become more exacting in recent years, accompanying the growing use of electrophotographic full-color copiers. In the framework of the Sustainable Development Goals (SDGs) adopted by the United Nations, in particular, efforts are being made worldwide that are aimed at curbing greenhouse gases such as CO₂, while energy conservation demands are likewise becoming stronger. Energy-saving approaches being addressed include techniques for fixing toner at a lower temperature, for the purpose of reducing power consumption in a fixing process.

It is known that a toner including, as a main component, a crystalline resin, which has a sharp melt property has low-temperature fixability superior to that of a toner including, as a main component, an amorphous resin.

For example, Japanese Patent Application Publication No. 2014-066994 proposes a toner that achieves both excellent low-temperature fixability and heat-resistant storage stability by having a crystalline resin as a matrix and an amorphous resin as domains. In addition, Japanese Patent Application Publication No. 2019-215527 proposes a toner using a crystalline vinyl resin.

### SUMMARY OF THE INVENTION

A toner including a crystalline vinyl resin, such as using behenyl acrylate, as the main component of the binder resin can be fixed at a lower fixing temperature than before. However, the inventors recognized that a toner containing a crystalline vinyl resin may have inferior abrasion resistance and hot offset resistance compared to the conventional toners.

The present disclosure is directed to a toner that has excellent low-temperature fixability, as well as excellent hot offset resistance and abrasion resistance.

The present disclosure relates to a toner comprising a toner particle comprising a binder resin and an inorganic fine particle, wherein
the binder resin comprises a crystalline vinyl resin having a monomer unit represented by a following formula (1),
a content of the monomer unit represented by the following formula (1) is at least 5.0% by mass, based on a mass of the crystalline vinyl resin,
the inorganic fine particle has at a surface thereof an alkyl group, and
a content of the inorganic fine particle is 0.10 to 15.00% by mass, based on the mass of the toner particle:

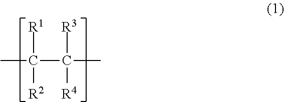

in formula (1), at least two of R¹ to R⁴ are each independently —X—COOR⁵, and the remaining are each independently a hydrogen atom or an alkyl group having 1 to 4 carbon atoms, X is a single bond or an alkylene group having 1 or 2 carbon atoms, and R⁵ is an alkyl group having 16 to 30 carbon atoms.

The present disclosure can provide a toner that has excellent low-temperature fixability, as well as excellent hot offset resistance and abrasion resistance.

Further features of the present invention will become apparent from the following description of exemplary embodiments.

### DESCRIPTION OF THE EMBODIMENTS

In the present disclosure, the descriptions “from XX to YY” and “XX to YY” that represent numerical ranges mean numerical ranges including the lower and upper limits that are the endpoints, unless otherwise specified. When numerical ranges are described in stages, the upper and lower limits of the numerical ranges can be combined in a freely selected manner.

In addition, in the present disclosure, for example, a description such as “at least one selected from the group consisting of XX, YY, and ZZ” means any of XX, YY, ZZ, a combination of XX and YY, a combination of XX and ZZ, a combination of YY and ZZ, or a combination of XX, YY, and ZZ.

“Monomer unit” refers to the reacted form of a monomer substance in a polymer. For example, one section of carbon-carbon bonds in the main chain of a polymer in which vinyl monomers are polymerized is considered to be one unit. A vinyl monomer can be expressed by a following formula (3).

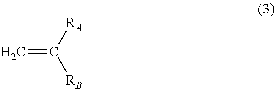

In formula (3), R_{A} represents a hydrogen atom or an alkyl group (preferably an alkyl group having 1 to 3 carbon atoms, more preferably a methyl group), and R_{B} represents any substituent.

Crystalline vinyl resin refers to a resin that shows a clear endothermic peak in differential scanning calorimetry (DSC) measurement and is synthesized from a freely selected vinyl monomer.

The present disclosure relates to a toner comprising a toner particle comprising a binder resin and an inorganic fine particle, wherein
the binder resin comprises a crystalline vinyl resin having a monomer unit represented by a following formula (1),
a content of the monomer unit represented by the following formula (1) is at least 5.0% by mass, based on a mass of the crystalline vinyl resin,
the inorganic fine particle has at a surface thereof an alkyl group, and
a content of the inorganic fine particle is 0.10 to 15.00% by mass, based on the mass of the toner particle:

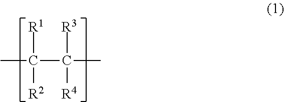

in formula (1), at least two of R¹ to R⁴ are each independently —X—COOR⁵, and the remaining are each independently a hydrogen atom or an alkyl group having 1 to 4 carbon atoms, X is a single bond or an alkylene group having 1 or 2 carbon atoms, and R⁵ is an alkyl group having 16 to 30 carbon atoms.

The inventors have considered the cause of deterioration of hot offset resistance of the toner containing the crystalline vinyl resin described above as follows. Crystalline vinyl resins, such as using behenyl acrylate, used in toners often have a melting point lower than the fixing temperature of the toner, and assume low viscosity when melted during fixing. However, toners using crystalline vinyl resins have low viscosity in a high-temperature range, and hot offset resistance thereof is likely to deteriorate.

In order to suppress this phenomenon, it is possible to increase the resin viscosity in a high-temperature range, but increasing the viscosity of the crystalline vinyl resin, or the amorphous resin used in combination reduces the low-temperature fixability. Therefore, it is difficult to solve the present problem by adjusting the viscosity of the crystalline vinyl resin and amorphous resin. Accordingly, the inventors of the present invention have conducted extensive research and found that by using inorganic fine particles surface-treated with an alkyl group, and a crystalline vinyl resin having a monomer unit represented by formula (1), it is possible to improve the hot offset resistance while maintaining the low-temperature fixability, and further improve the abrasion resistance.

The inventors consider the reason for this as follows. In the toner layer during fixing and melting, the alkyl groups of the crystalline vinyl resin interact with the alkyl groups on the surface of the inorganic fine particles, and the cohesive force of the toner layer during fixing and melting is strengthened. In particular, the interaction is strong when at least two alkyl groups R⁵ are present, as in the monomer unit represented by formula (1). As a result, even when the toner layer melts and flows, the dispersion of the inorganic fine particles is maintained, and the cohesive force is strengthened through the entire toner layer, thereby improving hot offset resistance. Furthermore, the same interaction also occurs in the toner layer after fixing, and abrasion resistance is also improved.

In the toner of the present disclosure, the binder resin includes a crystalline vinyl resin having a monomer unit represented by formula (1), and the content of the monomer unit represented by formula (1) is 5.0% by mass or more based on the mass of the crystalline vinyl resin. At least two of R¹ to R⁴ in formula (1) are each independently —X—COOR⁵, and the remaining are each independently a hydrogen atom or an alkyl group having 1 to 4 carbon atoms. X is a single bond or an alkylene group having 1 or 2 carbon atoms, and R⁵ is an alkyl group having 16 to 30 carbon atoms.

Because of the monomer unit represented by formula (1), the distance between the alkyl group side chains of the crystalline vinyl resin is shortened, which makes it easier for crystal domains in the toner to grow and improves the sharp melt property, thereby making it possible to obtain good low-temperature fixability. Where R⁵ exceeds 30, the low-temperature fixability tends to decrease. Also, where R⁵ is less than 16, the low-temperature fixability and storage stability tend to decrease, and the effect of improving hot offset resistance cannot be obtained.

To obtain more grown crystal domains, it is preferable that at least two of R¹ to R⁴ in formula (1) be —COOR⁵ (R⁵ is an alkyl group having 16 to 30 carbon atoms). In addition, in formula (1), it is more preferable that either R¹ or R² and either R³ or R⁴ are each independently —COOR⁵ (R⁵ is an alkyl group having 16 to 30 carbon atoms). R⁵ is preferably an alkyl group having 18 to 28 carbon atoms, and more preferably an alkyl group having 18 to 24 carbon atoms. It is preferable that the alkyl group of R⁵ be linear. It is even more preferable that R⁵ be a linear alkyl group having 18 carbon atoms or a linear alkyl group having 22 carbon atoms.

The crystalline vinyl resin contains 5.0% by mass or more of the monomer unit represented by formula (1) based on the mass of the crystalline vinyl resin. As a result of the content of the monomer unit represented by formula (1) being 5.0% by mass or more, the low-temperature fixability is improved. In addition, the effect of improving the hot offset resistance described above is also obtained. Since the low-temperature fixability is improved as the content of the monomer unit represented by formula (1) increases, the content of the monomer unit represented by formula (1) is preferably 30.0% by mass or more, and more preferably 50.0% by mass or more based on the mass of the crystalline vinyl resin. The content of the monomer unit represented by formula (1) is preferably 5.0% by mass to 85.0% by mass, more preferably 30.0% by mass to 80.0% by mass, and even more preferably 45.0% by mass to 75.0% by mass based on the mass of the crystalline vinyl resin.

Similarly, from the viewpoint of low-temperature fixability, the content of the crystalline vinyl resin is preferably 30% or more, and more preferably 50% or more based on the mass of the binder resin. Meanwhile, from the viewpoint of storage stability, the content of the crystalline vinyl resin is preferably 80% or less based on the mass of the binder resin. The content of the crystalline vinyl resin is preferably 30% by mass to 80% by mass, more preferably 50% by mass to 80% by mass, and even more preferably 50% by mass to 70% by mass based on the mass of the binder resin.

The toner particle includes a binder resin and inorganic fine particles. The inorganic fine particles have alkyl groups on their surfaces, and the content of the inorganic fine particles needs to be 0.10% by mass to 15.00% by mass based on the mass of the toner particle. When the content of the inorganic fine particles is within the above range, the alkyl groups of the crystalline vinyl resin and the alkyl groups on the surface of the inorganic fine particles interact with each other, strengthening the cohesive force of the toner layer, which results in good hot offset resistance and abrasion resistance.

Since the interaction intensifies as the number of inorganic fine particles that have alkyl groups on the surface increases, it is preferable, from the viewpoint of abrasion resistance and hot offset resistance, that the content of inorganic fine particles be 0.10% by mass or more, and preferably 1.00% by mass or more. Meanwhile, where the content of inorganic fine particles is high, the low-temperature fixability decreases due to the filler effect. From the viewpoint of low-temperature fixability, the content of inorganic fine particles needs to be 15.00% by mass or less, and preferably 13.00% by mass or less. The content of inorganic fine particles is preferably 1.00% by mass to 13.00% by mass, more preferably 7.00% by mass to 13.00% by mass, and even more preferably 9.00% by mass to 13.00% by mass based on the mass of the toner particles.

The alkyl groups on the inorganic fine particles are derived from, for example, a surface treatment agent. The inorganic fine particles can be surface-treated inorganic fine particles.

It is preferable that the inorganic fine particles be added internally to the toner particle. In cross-sectional observation of the toner using a transmission electron microscope, it is preferable that the toner particle includes the inorganic fine particles in a region that is 0.3 μm or more inside from the surface of the toner particle. This increases the viscosity inside the toner particle during fixing and increases the cohesive force in the entire toner layer formed by fixing and melting, resulting in good hot offset resistance.

In the present disclosure, the inside of the toner particle means a range that is not affected by an external additive present on the toner surface and means that 80% or more of the inorganic fine particles are enclosed in a region that is 0.3 μm or more inside from the surface of the toner particle. A specific measurement method will be described hereinbelow.

The toner has a particle diameter that is common for toners. Specifically, the weight-average particle diameter (D4) of the toner is preferably 3.0 μm to 10.0 μm, and more preferably 4.0 μm to 8.0 μm. Discussed in the present disclosure is the region that is 0.3 μm or more inside from the surface of the toner particle in a toner having such a particle diameter.

A method enabling the presence of the inorganic fine particles in the region that is 0.3 μm or more inside from the surface of the toner particle is exemplified by the following methods. A pulverizing method in which raw materials such as a binder resin and wax are melted and kneaded, and the kneaded product is cooled and then pulverized and classified, the inorganic fine particles being mixed with other raw materials in advance in the raw material mixing step; a suspension granulation method in which a solution obtained by dissolving or dispersing a binder resin, wax, and the inorganic fine particles in a solvent is introduced into an aqueous medium, suspension and granulation are carried out, and the solvent is removed to obtain toner particles; a suspension polymerization method in which a monomer composition obtained by uniformly dissolving or dispersing the inorganic fine particles, wax and the like in a monomer is dispersed in a continuous layer (for example, an aqueous phase) containing a dispersion stabilizer, and a polymerization reaction is carried out to produce toner particles; a method in which the inorganic fine particles are introduced in advance in a monomer composition in an emulsion polymerization method in which toner particles are produced by direct polymerization in the presence of a water-soluble polar polymerization initiator; an emulsion aggregation method including a step of forming fine particle aggregates by aggregating at least polymer fine particles, wax, and the inorganic fine particles and an aging step of causing the fine particles in the fine particle aggregates to fuse together; and a method in which a shell that does not contain the inorganic fine particles is coated on the surface of a core fine particle containing the inorganic fine particles to form a fine particle having a core-shell structure.

The number-average particle diameter of the primary particles of the inorganic fine particles is preferably 10 nm to 500 nm, and more preferably 100 nm to 300 nm. By satisfying the above number-average particle diameter, the alkyl groups present on the surface of the inorganic fine particles and the alkyl groups in the crystalline vinyl resin are more likely to interact with each other, resulting in better abrasion resistance and hot offset resistance.

The content of the alkyl groups on the surface of the inorganic fine particles is preferably 0.10% by mass to 5.00% by mass, and more preferably 0.15% by mass to 3.20% by mass based on the mass of the inorganic fine particles.

By satisfying the above content, the alkyl groups present on the surface of the inorganic fine particles and the alkyl groups in the crystalline vinyl resin are more likely to interact with each other, resulting in better abrasion resistance and hot offset resistance. Furthermore, where the content of the alkyl groups on the surface of the inorganic fine particles is 5.00% by mass or less based on the mass of the inorganic fine particles, gloss is likely to be improved.

It is also preferable that the difference between the number of carbon atoms of the alkyl group on the surface of the inorganic fine particles and the number of carbon atoms of R⁵ in formula (1) be 5 or less. The difference is preferably 0 to 5, and more preferably 1 to 4.

By satisfying the difference in the number of carbon atoms, the alkyl group present on the surface of the inorganic fine particles and the alkyl group in the crystalline vinyl resin are more likely to interact with each other, resulting in better abrasion resistance and hot offset resistance.

When multiple types of alkyl groups with different numbers of carbon atoms are present on the surface of the inorganic fine particles, a weighted average value weighted by the number of moles (mol %) of the alkyl groups is adopted. Similarly, when multiple types of alkyl groups with different numbers of carbon atoms are used for R⁵ in formula (1), a weighted average value weighted by the number of moles (mol %) of the alkyl groups is adopted.

It is also preferable that the content (% by mass) of the monomer unit represented by formula (1) based on the mass of the toner particle be 20 times or more the content (% by mass) of the alkyl groups on the surface of the inorganic fine particles based on the mass of the toner particle. The content (% by mass) of the monomer unit represented by formula (1) based on the mass of the toner particle is preferably 20 to 8000 times, more preferably 20 to 1500 times, and even more preferably 80 to 150 times the content (% by mass) of the alkyl groups on the surface of the inorganic fine particles based on the mass of the toner particle.

By satisfying this content relationship, the alkyl groups present on the surface of the inorganic fine particles and the alkyl groups in the crystalline vinyl resin are more likely to interact with each other, resulting in better abrasion resistance and hot offset resistance.

In the crystalline vinyl resin, the monomer unit represented by formula (1) is, for example, a monomer unit formed by at least one polymerizable monomer selected from ester compounds obtained by reacting a carboxylic acid having at least two carboxyl groups bonded to a carbon-carbon double bond with an alcohol having at least two alkyl groups having 16 to 30 carbon atoms.

Examples of ester compounds obtained by reacting a carboxylic acid having at least two carboxyl groups bonded to a carbon-carbon double bond with an alcohol having at least two alkyl groups with 16 to 30 carbon atoms include diesters of fumaric acid and an alcohol having an alkyl group having 16 to 30 carbon atoms [distearyl fumarate, dinonadecyl fumarate, dieicosyl fumarate, diheneicosanyl fumarate, dibehenyl fumarate, dilignoceryl fumarate, dioctacosyl fumarate, dimyrisyl fumarate, didotriacontyl fumarate, and the like]; esters of fumaric acid and two alcohols each having an alkyl group having 16 to 30 carbon atoms [behenylstearyl fumarate and the like]; diesters of maleic acid and an alcohol having an alkyl group having 16 to 30 carbon atoms [distearyl maleate, dinonadecyl maleate, dieicosyl maleate, diheneicosanyl maleate, dibehenyl maleate, dilignoceryl maleate, dioctacosyl maleate, dimyrisyl maleate, didotriacontyl maleate, and the like]; esters of maleic acid and two alcohols each having an alkyl group having 16 to 30 carbon atoms [dibehenylstearyl maleate and the like]; diesters of methylenemalonic acid and an alcohol having an alkyl group having 16 to 30 carbon atoms [distearyl methylenemalonate, dinonadecyl methylenemalonate, dieicosyl methylenemalonate, diheneicosanyl methylenemalonate, dibehenyl methylenemalonate, dilignoceryl methylenemalonate, dioctacosyl methylenemalonate, dimyrisyl methylenemalonate, didotriacontyl methylenemalonate, and the like]; esters of methylenemalonic acid and two alcohols each having an alkyl group having 16 to 30 carbon atoms [behenylstearyl methylenemalonate and the like]; diesters of itaconic acid and an alcohol having an alkyl group having 16 to 30 carbon atoms [distearyl itaconate, dinonadecyl itaconate, dieicosyl itaconate, diheneicosanyl itaconate, dibehenyl itaconate, dilignoceryl itaconate, dioctacosyl itaconate, dimyrisyl itaconate, didotriacontyl itaconate, and the like); and esters of itaconic acid and two alcohols each having an alkyl group having 16 to 30 carbon atoms [behenylstearyl itaconate and the like].

Further examples include ester compounds of ethenetricarboxylic acid and an alcohol having an alkyl group having 16 to 30 carbon atoms. Other examples include ester compounds of ethenetetracarboxylic acid and an alcohol having an alkyl group having 16 to 30 carbon atoms.

From the viewpoint of low-temperature fixability of the toner, it is preferable that the ester compound be at least one selected from the group consisting of an ester compound of fumaric acid and an alcohol having an alkyl group having 16 to 30 carbon atoms, and an ester compound of maleic acid and an alcohol having an alkyl group having 16 to 30 carbon atoms. More preferably, the ester compound is at least one selected from the group consisting of an ester compound of fumaric acid and an alcohol having an alkyl group having 16 to 30 carbon atoms. It is preferable that the alkyl group in these polymerizable monomers be linear.

The polymerizable monomer capable of forming the monomer unit represented by formula (1) may be used alone or in combination of two or more kinds.

The crystalline vinyl resin may contain, as necessary, other monomer units in addition to the monomer unit represented by formula (1) to the extent that the effects of the present disclosure are not impaired.

Examples of polymerizable monomers that form other monomer units include monomers having a nitrile group, such as acrylonitrile and methacrylonitrile, and also include 2-hydroxyethyl (meth)acrylate, 2-hydroxypropyl (meth)acrylate, 2-hydroxyethylamide (meth)acrylate, 2-hydroxypropylamide (meth)acrylate, and the like.

Among these, it is preferable to use at least one polymerizable monomer selected from the group consisting of acrylonitrile, methacrylonitrile, acrylic acid, and methacrylic acid. With this combination, a toner having excellent low-temperature fixability, hot offset resistance, and abrasion resistance is obtained. It is more preferable to use at least one polymerizable monomer selected from the group consisting of acrylonitrile and methacrylonitrile, and at least one polymerizable monomer selected from the group consisting of 2-hydroxyethyl (meth)acrylate and 2-hydroxypropyl (meth)acrylate.

The crystalline vinyl resin preferably contains a monomer unit represented by the following formula (N). The monomer units represented by the following formula (N) correspond to acrylonitrile and methacrylonitrile. The crystalline vinyl resin preferably contains a monomer unit represented by the following formula (H). The monomer units represented by formula (H) correspond to 2-hydroxyethyl (meth)acrylate, 2-hydroxypropyl (meth)acrylate, and the like. That is, the crystalline vinyl resin preferably contains at least one monomer unit selected from the group consisting of a monomer unit represented by the following formula (N) and a monomer unit represented by the following formula (H).

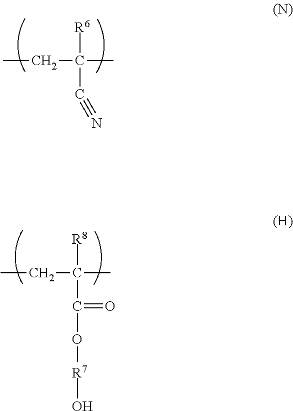

In formula (N), R⁶ is a hydrogen atom or a methyl group. In formula (H), R⁷ is an alkylene group having 1 to 4 (preferably, 2 or 3) carbon atoms, and R⁸ is a hydrogen atom or a methyl group. The content of the monomer unit represented by formula (N) in the crystalline vinyl resin is preferably 1.0% by mass to 45.0% by mass, and more preferably 5.0% by mass to 25.0% by mass. The crystalline vinyl resin contains the monomer unit represented by formula (H) in an amount of preferably 1.0% by mass to 20.0% by mass, and more preferably 3.0% by mass to 10.0% by mass. The total content of the monomer unit represented by formula (N) and the monomer unit represented by formula (H) in the crystalline vinyl resin is preferably 5.0% by mass to 50.0% by mass, and more preferably 10.0% by mass to 20.0% by mass.

Other examples of polymerizable monomers that form monomer units other than the monomer unit represented by formula (1) include the following polymerizable monomers.

Monomers having an amide group: for example, acrylamides and monomers obtained by reacting an amine having 1 to 30 carbon atoms with a carboxylic acid having 2 to 30 carbon atoms and an ethylenically unsaturated bond (acrylic acid, methacrylic acid, and the like) by a known method.

Monomers having a urea group: for example, monomers obtained by reacting an amine having 3 to 22 carbon atoms [primary amines (normal butylamine, t-butylamine, propylamine, isopropylamine, and the like), secondary amines (di-normal ethylamine, di-normal propylamine, di-normal butylamine, and the like), aniline, cycloxylamine, and the like] with an isocyanate having 2 to 30 carbon atoms and an ethylenically unsaturated bond by a known method.

Monomers having a carboxy group: for example, methacrylic acid, acrylic acid, 2-carboxyethyl (meth)acrylate.

Vinyl esters; for example, vinyl acetate, vinyl propionate, vinyl butyrate, vinyl caproate, vinyl caprylate, vinyl caprate, vinyl laurate, vinyl myristate, vinyl palmitate, vinyl stearate, vinyl pivalate, and vinyl octylate.

Styrene and derivatives thereof: styrene, o-methylstyrene, and the like.

(Meth)acrylic acid esters: methyl (meth)acrylate, n-butyl (meth)acrylate, t-butyl (meth)acrylate, 2-ethylhexyl (meth)acrylate, and the like.

Unsaturated polyenes: unsaturated monoolefins such as ethylene, propylene, butylene, and isobutylene; butadiene, isoprene, and the like.

Aromatic divinyl compounds: diacrylate compounds linked by alkyl chains; diacrylate compounds linked by alkyl chains containing ether bonds; diacrylate compounds linked by chains containing aromatic groups and ether bonds; polyester-type diacrylates; and polyfunctional crosslinking agents.

Examples of the aromatic divinyl compounds include divinylbenzene, divinylnaphthalene, and the like.

Examples of diacrylate compounds linked by alkyl chains include ethylene glycol diacrylate, 1,3-butylene glycol diacrylate, 1,4-butanediol diacrylate, 1,5-pentanediol diacrylate, 1,6-hexanediol diacrylate, neopentyl glycol diacrylate, and compounds in which the acrylate of the above compounds is replaced with a methacrylate.

Among these, the use of styrene and derivatives thereof such as styrene and o-methylstyrene ensures good hot offset resistance. More preferably, the crystalline vinyl resin contains a monomer unit corresponding to styrene. The crystalline vinyl resin contains preferably 5.0% by mass to 75.0% by mass, and more preferably 10.0% by mass to 40.0% by mass of the monomer unit corresponding to styrene.

Furthermore, preferably, the crystalline vinyl resin contains a monomer unit corresponding to a (meth)acrylic acid ester. The crystalline vinyl resin preferably contains 0.0% by mass to 5.0% by mass, more preferably 0.5% by mass to 3.0% by mass of a monomer unit corresponding to a (meth)acrylic acid ester.

The crystalline vinyl resin can be produced using the exemplified polymerizable monomers and polymerization initiators. From the viewpoint of efficiency, the polymerization initiator is preferably used in an amount of from 0.05 parts by mass to 10 parts by mass per 100 parts by mass of the polymerizable monomers.

Examples of the polymerization initiator include the following.

ketone peroxides such as 2,2′-azobisisobutyronitrile, 2,2′-azobis(4-methoxy-2,4-dimethylvaleronitrile), 2,2′-azobis(2,4-dimethylvaleronitrile), 2,2′-azobis(2-methylbutyronitrile), dimethyl-2,2′-azobis isobutyrate, 1,1′-azobis(1-cyclohexanecarbonitrile), 2-carbamoylazoisobutyronitrile, 2,2′-azobis(2,4,4-trimethylpentane), 2-phenylazo-2,4-dimethyl-4-methoxyvaleronitrile, 2,2′-azobis(2-methylpropane), methyl ethyl ketone peroxide, acetylacetone peroxide and cyclohexanoneperoxide; as well as 2,2-bis(tert-butyl peroxy)butane, tert-butylhydroperoxide, methanehydroperoxide, 1,1,3,3-tetramethylbutylhydroperoxide, di-tert-butyl peroxide, tert-butylcumyl peroxide, dicumyl peroxide, α,α′-bis(tert-butyl peroxyisopropyl)benzene, isobutyl peroxide, octanoyl peroxide, decanoyl peroxide, lauroyl peroxide, 3,5,5-trimethylhexanoyl peroxide, benzoyl peroxide, m-trioyl peroxide, diisopropyl peroxydicarbonate, di-2-ethylhexyl peroxydicarbonate, di-n-propyl peroxydicarbonate, di-2-ethoxyethyl peroxycarbonate, dimethoxyisopropyl peroxydicarbonate, di(3-methyl-3-methoxybutyl)peroxycarbonate, acetylcyclohexylsulfonyl peroxide, tert-butyl peroxyacetate, tert-butyl peroxyisobutyrate, tert-butyl peroxyneodecanoate, tert-butyl peroxy-2-ethylhexanoate, tert-butyl peroxylaurate, tert-butyl peroxybenzoate, tert-butyl peroxyisopropyl carbonate, di-tert-butyl peroxyisophthalate, tert-butyl peroxyallyl carbonate, tert-amyl peroxy-2-ethylhexanoate, di-tert-butyl peroxyhexahydroterephthalate and di-tert-butyl peroxyazelate.

From the viewpoint of charge stability, the crystalline vinyl resin preferably has an acid value of 0 mg KOH/g to 100 mg KOH/g, and more preferably 0 mg KOH/g to 50 mg KOH/g. Similarly, the hydroxyl value is preferably 0 mg KOH/g to 100 mg KOH/g, and more preferably 0 mg KOH/g to 50 mg KOH/g.

The weight-average molecular weight Mw of the crystalline vinyl resin is not particularly limited, but is preferably 10000 to 100000, and more preferably 15000 to 30000.

The binder resin may include an amorphous resin. Any known amorphous resin may be used to the extent that it does not impair the effects of the present disclosure. From the viewpoint of low-temperature fixability, it is preferable that the binder resin include 30% by mass to 80% by mass of crystalline vinyl resin.

Examples of known amorphous resins include the following.

Polyvinyl chloride, phenolic resins, natural resin-modified phenolic resins, natural resin-modified maleic acid resins, polyvinyl acetate, silicone resins, polyester resins, polyurethane resins, polyamide resins, furan resins, epoxy resins, xylene resins, polyvinyl butyral, terpene resins, coumarone-indene resin, petroleum resins, and vinyl resins.

Among these, the amorphous resin preferably contains at least one resin selected from the group consisting of hybrid resins in which a vinyl resin and a polyester resin are bonded, polyester resins, and vinyl resins. The amorphous resin more preferably contains an amorphous polyester resin. The use of an amorphous polyester resin is preferable because it makes it easier to achieve both low-temperature fixability and hot offset resistance at a high level.

Polyester resins that are ordinarily used in toners can be suitably used herein as the amorphous polyester resin. Examples of the monomers used in the above polyester resin include polyhydric alcohols (dihydric, trihydric or higher alcohols), and polyvalent carboxylic acids (divalent, trivalent or higher carboxylic acids) and acid anhydrides or lower alkyl esters thereof.

Examples of the above polyhydric alcohols include those set out below.

Examples of dihydric alcohols include the following bisphenol derivatives.

Polyoxypropylene (2.2)-2,2-bis(4-hydroxyphenyl)propane, polyoxypropylene (3.3)-2,2-bis(4-hydroxyphenyl)propane, polyoxyethylene (2.0)-2,2-bis(4-hydroxyphenyl)propane, polyoxypropylene (2.0)-polyoxyethylene (2.0)-2,2-bis(4-hydroxyphenyl)propane, polyoxypropylene (6)-2,2-bis(4-hydroxyphenyl)propane and the like.

Other polyhydric alcohols include ethylene glycol, diethylene glycol, triethylene glycol, 1,2-propanediol, 1,3-propanediol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, polytetramethylene glycol, sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerin, 2-methylpropanetriol, 2-methyl-1,2,4-butanetriol, trimethylolethane, tritrimethylolpropane and 1,3,5-trihydroxymethylbenzene.

These polyhydric alcohols can be used singly or in combinations of a plurality thereof.

Examples of the above polyvalent carboxylic acids include those below.

Examples of divalent carboxylic acids include maleic acid, fumaric acid, citraconic acid, itaconic acid, glutaconic acid, phthalic acid, isophthalic acid, terephthalic acid, succinic acid, adipic acid, sebacic acid, azelaic acid, malonic acid, n-dodecenylsuccinic acid, isododecenylsuccinic acid, n-dodecylsuccinic acid, isododecylsuccinic acid, n-octenylsuccinic acid, n-octylsuccinic acid, isooctenylsuccinic acid and isooctylsuccinic acid, as well as anhydrides and lower alkyl esters of these acids. Preferably among the foregoing there is used maleic acid, fumaric acid, terephthalic acid, n-dodecenylsuccinic acid or adipic acid.

As the divalent carboxylic acid, an alkenyl succinic acid such as n-dodecenyl succinic acid, isododecenyl succinic acid, n-octenyl succinic acid, or isooctenyl succinic acid may be used. Since these alkenyl succinic acids have an alkenyl group, they are likely to interact with the long-chain alkyl units of the crystalline vinyl resin. Since this interaction is weaker than the interaction between polar groups, the filler effect is easily exhibited due to the interaction when the strain is small, but the filler effect is unlikely to be exhibited when the strain is large. As a result, the toner may may have better low-temperature fixability.

Examples of trivalent or higher carboxylic acids, anhydrides, and lower alkyl esters thereof include the following:

1,2,4-benzenetricarboxylic acid (trimellitic acid), 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl)methane, 1,2,7,8-octanetetracarboxylic acid, pyromellitic acid, empol trimer acid, anhydrides thereof, and lower alkyl esters thereof.

Among these, 1,2,4-benzenetricarboxylic acid (trimellitic acid) and derivatives thereof such as anhydrides are preferably used because they are inexpensive and the reaction can be easily controlled.

These polyvalent carboxylic acids can be used alone or a plurality thereof may be used combination.

Also, linear saturated fatty acids such as behenic acid may be used.

The method for producing the polyester resin is not particularly limited, and a known method can be resorted to herein. For instance, a polyhydric alcohol and a polyvalent carboxylic acid described above are simultaneously charged, and are polymerized as a result of an esterification reaction or a transesterification reaction, and a condensation reaction, to produce a polyester resin. The polymerization temperature is not particularly limited, but lies preferably in the range from 180° C. to 290° C. For instance a polymerization catalyst such as a titanium-based catalyst, a tin-based catalyst, zinc acetate, antimony trioxide or germanium dioxide can be used in polymerization of polyester resins.

The polyester resin used in the amorphous resin is preferably obtained through condensation polymerization using at least one from among a titanium-based catalyst and a tin-based catalyst.

Examples of amorphous vinyl resins used as amorphous resins include polymers of polymerizable monomers containing ethylenically unsaturated bonds. The term ethylenically unsaturated bond denotes a carbon-carbon double bond capable of undergoing radical polymerization, and may be for instance a vinyl group, a propenyl group, an acryloyl group or a methacryloyl group.

Examples of polymerizable monomers include the following.

Styrenic monomers such as styrene, o-methylstyrene, m-methylstyrene, p-methylstyrene, p-phenylstyrene, p-ethylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxy styrene, p-chlorostyrene, 3,4-dichlorostyrene, m-nitrostyrene, o-nitrostyrene, p-nitrostyrene;
acrylic acids and acrylic acid esters such as acrylic acid, methyl acrylate, ethyl acrylate, propyl acrylate, n-butyl acrylate, isobutyl acrylate, n-octyl acrylate, dodecyl acrylate, 2-ethylhexyl acrylate, stearyl acrylate, 2-chloroethyl acrylate and phenyl acrylate;
methacrylic acids and methacrylic acid esters such as methacrylic acid, methyl methacrylate, ethyl methacrylate, propyl methacrylate, n-butyl methacrylate, isobutyl methacrylate, n-octyl methacrylate, dodecyl methacrylate, 2-ethylhexyl methacrylate, stearyl methacrylate, phenyl methacrylate, dimethylaminoethyl methacrylate and diethylaminoethyl methacrylate;
as well as acrylonitrile, methacrylonitrile and acrylamide.

Further examples include acrylic acid esters or methacrylic acid esters such as 2-hydroxyethyl acrylate, 2-hydroxyethyl methacrylate, 2-hydroxypropyl methacrylate, as well as polymerizable monomers having a hydroxy group, such as 4-(1-hydroxy-1-methylbutyl) styrene and 4-(1-hydroxy-1-methylhexyl) styrene. The foregoing can be used singly or in combinations of a plurality of types thereof.

Among these, styrene, acrylic acid esters, methacrylic acid esters, acrylonitrile, and the like are preferred. Also, monomers that are condensates of acrylic acid or methacrylic acid with alcohols having 6 to 22 carbon atoms, such as n-octyl acrylate, dodecyl acrylate, 2-ethylhexyl acrylate, stearyl acrylate, n-octyl methacrylate, dodecyl methacrylate, 2-ethylhexyl methacrylate, and stearyl methacrylate, may be used.

These monomers tend to interact with the long-chain alkyl units of the crystalline vinyl resin. Since this interaction is weaker than the interaction between polar groups, the filler effect is easily exhibited due to the interaction when the strain is small, but the filler effect is unlikely to be exhibited when the strain is large. As a result, the toner may have better low-temperature fixability.

Besides the above resins, various polymerizable monomers that are amenable to vinyl polymerization may be used concomitantly, as needed, in the amorphous vinyl resin.

Examples of such polymerizable monomers include the following.

Unsaturated monoolefins such as ethylene, propylene, butylene and isobutylene; unsaturated polyenes such as butadiene and isoprene; vinyl halides such as vinyl chloride, vinylidene chloride, vinyl bromide and vinyl fluoride; vinyl esters such as vinyl acetate, vinyl propionate and vinyl benzoate; vinyl ethers such as vinyl methyl ether, vinyl ethyl ether and vinyl isobutyl ether; vinyl ketones such as vinyl methyl ketone, vinyl hexyl ketone and methyl isopropenyl ketone; N-vinyl compounds such as N-vinylpyrrole, N-vinylcarbazole, N-vinylindole and N-vinylpyrrolidone; vinylnaphthalenes; as well as polymerizable monomers having a carboxy group, for instance unsaturated dibasic acids such as maleic acid, citraconic acid, itaconic acid, alkenylsuccinic acids, fumaric acid and mesaconic acid; unsaturated dibasic anhydrides such as maleic anhydride, citraconic anhydride, itaconic anhydride and alkenylsuccinic anhydrides; half esters of unsaturated dibasic acids such as methyl maleate half ester, ethyl maleate half ester, butyl maleate half ester, methyl citraconate half ester, ethyl citraconate half ester, butyl citraconate half ester, methyl itaconate half ester, methyl alkenylsuccinate half esters, methyl fumarate half ester and methyl mesaconate half ester; unsaturated basic acid esters such as maleic acid dimethyl ester and fumaric acid dimethyl ester; acid anhydrides of α,β-unsaturated acids such as acrylic acid, methacrylic acid, crotonic acid and cinnamic acid; anhydrides of these α,β-unsaturated acids and lower fatty acids; alkenyl malonic acids, alkenyl glutaric acids and alkenyl adipic acids; as well as acid anhydrides of the foregoing, and monoesters of the foregoing.

As the case may require, the amorphous vinyl resin may be a polymer crosslinked with a crosslinking polymerizable monomer such as those exemplified below.

Examples of the crosslinking polymerizable monomer include the following.

Aromatic divinyl compounds; diacrylate compounds having an alkyl chain bridge; diacrylate compounds having an alkyl chain bridge containing an ether bond; diacrylate compounds having a bridge of a chain containing an aromatic group and an ether bond; polyester-type diacrylates; and multifunctional crosslinking agents.

Examples of aromatic divinyl compounds include divinylbenzene and divinylnaphthalene.

Examples of the above diacrylate compounds having an alkyl chain bridge include ethylene glycol diacrylate, 1,3-butylene glycol diacrylate, 1,4-butanediol diacrylate, 1,5-pentanediol acrylate, 1,6-hexanediol diacrylate, neopentyl glycol diacrylate, and compounds resulting from replacing the acrylate in the foregoing compounds with methacrylate.

The amorphous vinyl resin is preferably a polymer of polymerizable monomers including at least one selected from the group consisting of styrene, o-methylstyrene, m-methylstyrene, p-methylstyrene, p-phenylstyrene, p-ethylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxystyrene, p-chlorostyrene, 3,4-dichlorostyrene, m-nitrostyrene, o-nitrostyrene, p-nitrostyrene, acrylic acid, methyl acrylate, ethyl acrylate, propyl acrylate, n-butyl acrylate, isobutyl acrylate, n-octyl acrylate, dodecyl acrylate, 2-ethylhexyl acrylate, stearyl acrylate, 2-chloroethyl acrylate, phenyl acrylate, methacrylic acid, methyl methacrylate, ethyl methacrylate, propyl methacrylate, n-butyl methacrylate, isobutyl methacrylate, n-octyl methacrylate, dodecyl methacrylate, 2-ethylhexyl methacrylate, stearyl methacrylate, phenyl methacrylate, dimethylaminoethyl methacrylate, diethylaminoethyl methacrylate, acrylonitrile, methacrylonitrile, acrylamide, 2-hydroxyethyl acrylate, 2-hydroxyethyl methacrylate, 2-hydroxypropyl methacrylate, 4-(1-hydroxy-1-methylbutyl)styrene and 4-(1-hydroxy-1-methylhexyl)styrene.

The amorphous vinyl resin may be a copolymer of at least one polymerizable monomer selected from the above group, and a monomer including at least one crosslinking polymerizable monomer selected from the group consisting of divinylbenzene, divinylnaphthalene, ethylene glycol diacrylate, 1,3-butylene glycol diacrylate, 1,4-butanediol diacrylate, 1,5-pentanediol diacrylate, 1,6-hexanediol diacrylate, neopentyl glycol diacrylate, ethylene glycol dimethacrylate, 1,3-butylene glycol dimethacrylate, 1,4-butanediol dimethacrylate, 1,5-pentanediol dimethacrylate, 1,6-hexanediol dimethacrylate and neopentyl glycol dimethacrylate. The content ratio of the crosslinking monomer among the monomers may be set to from about 0.5 mass % to 5.0 mass %.

The amorphous vinyl resin may be a resin produced using a polymerization initiator. From the viewpoint of efficiency, the polymerization initiator may be used in an amount from 0.05 parts by mass to 10 parts by mass relative to 100 parts by mass of the polymerizable monomers. Examples of the polymerization initiator include the following.

ketone peroxides such as 2,2′-azobisisobutyronitrile, 2,2′-azobis(4-methoxy-2,4-dimethylvaleronitrile), 2,2′-azobis(2,4-dimethylvaleronitrile), 2,2′-azobis(2-methylbutyronitrile), dimethyl-2,2′-azobis isobutyrate, 1,1′-azobis(1-cyclohexanecarbonitrile), 2-carbamoylazoisobutyronitrile, 2,2′-azobis(2,4,4-trimethylpentane), 2-phenylazo-2,4-dimethyl-4-methoxyvaleronitrile, 2,2′-azobis(2-methylpropane), methyl ethyl ketone peroxide, acetylacetone peroxide and cyclohexanoneperoxide; as well as 2,2-bis(tert-butyl peroxy)butane, tert-butylhydroperoxide, methanehydroperoxide, 1,1,3,3-tetramethylbutylhydroperoxide, di-tert-butyl peroxide, tert-butylcumyl peroxide, dicumyl peroxide, α,α′-bis(tert-butyl peroxyisopropyl)benzene, isobutyl peroxide, octanoyl peroxide, decanoyl peroxide, lauroyl peroxide, 3,5,5-trimethylhexanoyl peroxide, benzoyl peroxide, m-trioyl peroxide, diisopropyl peroxydicarbonate, di-2-ethylhexyl peroxydicarbonate, di-n-propyl peroxydicarbonate, di-2-ethoxyethyl peroxycarbonate, dimethoxyisopropyl peroxydicarbonate, di(3-methyl-3-methoxybutyl)peroxycarbonate, acetylcyclohexylsulfonyl peroxide, tert-butyl peroxyacetate, tert-butyl peroxyisobutyrate, tert-butyl peroxyneodecanoate, tert-butyl peroxy-2-ethylhexanoate, tert-butyl peroxylaurate, tert-butyl peroxybenzoate, tert-butyl peroxyisopropyl carbonate, di-tert-butyl peroxyisophthalate, tert-butyl peroxyallyl carbonate, tert-amyl peroxy-2-ethylhexanoate, di-tert-butyl peroxyhexahydroterephthalate and di-tert-butyl peroxyazelate.

The same vinyl resins and polyester resins used as the above-described amorphous resin can be utilized herein as the vinyl resin and polyester resin that are used to form a hybrid resin in which the vinyl resin and the polyester resin are bonded to each other.

Examples of the method for producing a hybrid resin in which a vinyl resin and a polyester resin are bonded to each other include for instance a polymerization method that utilizes a compound (hereafter “bireactive compound”) that can react with any of the monomers that generate both resins.

Examples of the bireactive compounds include compounds such as fumaric acid, acrylic acid, methacrylic acid, citraconic acid, maleic acid, and dimethyl fumarate from among the monomers of the condensation polymerization resin or the monomers of the addition polymerization resin. Of these, fumaric acid, acrylic acid, and methacrylic acid are preferably used.

In a case where a hybrid resin is used in which a vinyl resin and a polyester resin are bonded to each other, the content ratio of the vinyl resin in the hybrid resin is preferably 10 mass % or more, 20 mass % or more, 40 mass % or more, 60 mass % or more or 80 mass % or more, and preferably 100 mass % or less, or 90 mass % or less.

The inorganic fine particles have alkyl groups on the surface. For example, the inorganic fine particles are surface-treated with a compound having alkyl groups. In other words, the inorganic fine particles are preferably surface-treated with a compound having alkyl groups.

Where the inorganic fine particles have alkyl groups on the surface, these alkyl groups can interact with the alkyl groups of the crystalline vinyl resin, resulting in good abrasion resistance and hot offset resistance.

Examples of compounds having alkyl groups include fatty acids or metal salts thereof, silicone oils, cyclic siloxanes, silane coupling agents, titanium coupling agents, aliphatic alcohols, and the like. Among these, it is preferable for the compound having alkyl groups to include at least one selected from the group consisting of fatty acids and metal salts thereof, silicone oils, cyclic siloxanes, and silane coupling agents, since good abrasion resistance and hot offset resistance are more likely to be obtained.

Examples of fatty acids and metal salts thereof include lauric acid, stearic acid, behenic acid, lithium laurate, lithium stearate, sodium stearate, zinc laurate, zinc stearate, calcium stearate, aluminum stearate, and the like.

Examples of silicone oils include dimethyl silicone oil, methylphenyl silicone oil, a-methylstyrene-modified silicone oil, alkyl-modified silicone oils, and the like. Publicly known methods can be used for silicone oil treatment. For example, the inorganic fine particles and silicone oil are mixed using a mixer; silicone oil is sprayed onto the inorganic fine particles using a sprayer; or silicone oil is dissolved in a solvent and then mixed with the inorganic fine particles. The treatment method is not limited to these.

Examples of cyclic siloxanes include cyclic siloxanes (having, for example, 3 to 8 dimethylsiloxane units) such as octamethylcyclotetrasiloxane (D4), decamethylcyclopentasiloxane (D5), dodecamethylcyclohexasiloxane (D6), and the like.

Examples of silane coupling agents include hexamethyldisilazane, trimethylsilane, trimethylethoxysilane, isobutyltrimethoxysilane, trimethylchlorosilane, dimethyldichlorosilane, methyltrichlorosilane, dimethylethoxysilane, dimethyldimethoxysilane, octyltrimethoxysilane, decyltrimethoxysilane, and cetyltrimethoxysilane.

Examples of aliphatic alcohols include ethanol, n-propanol, 2-propanol, n-butanol, t-butanol, n-octanol, stearyl alcohol, and 1-tetracosanol. For example, inorganic fine particles can be treated with an aliphatic alcohol that was heated to a temperature above the boiling point and vaporized.

Examples of inorganic fine particles include oxide fine particles composed of silica, alumina, titania, magnesium oxide, zirconium oxide, chromium oxide, cerium oxide, tin oxide, zinc oxide, and the like, as well as inorganic fine particles composed of amorphous carbon (carbon black and the like), nitrides (silicon nitride and the like), carbides (silicon carbide and the like), and metal salts (strontium titanate, calcium sulfate, barium sulfate, calcium carbonate, and the like).

In particular, it is preferable that the inorganic fine particles include at least one selected from the group consisting of calcium carbonate, silica, titanium oxide, alumina, metal titanates, magnesium silicate, and barium sulfate. It is more preferable that the inorganic fine particles include calcium carbonate. It is preferable that the inorganic fine particles be treated with a hydrophobizing agent such as a fatty acid, a silane compound, polydimethylsiloxane, a cyclic siloxane, bis(trimethylsilyl)amine, a silicone oil, or a mixture thereof.

The number-average diameter of the primary particles of the inorganic fine particles having alkyl groups on the surface is preferably 10 nm to 500 nm, since better hot offset resistance and abrasion resistance are likely to be exhibited. In addition, inorganic fine particles other than those described above may be contained, regardless of the presence or absence of surface treatment, to an extent that does not impair the effects of the present disclosure. In addition, among the inorganic fine particles having alkyl groups on the surface, it is preferable that the difference in the number of carbon atoms from the R⁵ be 5 or less, since the interaction with the alkyl groups of the monomer units of formula (1) is further improved, and hot offset resistance and abrasion resistance are further improved.

In addition, as the inorganic fine particles having alkyl groups on the surface in the toner particles, one type may be used alone, or two or more types may be contained.

The toner particles may contain a colorant, if necessary, in addition to the inorganic fine particles. Examples of colorants include the following.

Examples of black colorants include carbon black; and materials that are colored black through use of yellow colorants, magenta colorants and cyan colorants. The colorant may be a single pigment, but using a colorant obtained by combining a dye and a pigment and improving the clarity is more preferred from the perspective of full color image quality.

Examples of a pigment for a magenta toner include the following.

C. I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48:2, 48:3, 48:4, 49, 50, 51, 52, 53, 54, 55, 57:1, 58, 60, 63, 64, 68, 81:1, 83, 87, 88, 89, 90, 112, 114, 122, 123, 146, 147, 150, 163, 184, 202, 206, 207, 209, 238, 269, 282; C. I. Pigment Violet 19; C. I. Vat Red 1, 2, 10, 13, 15, 23, 29, 35.

Examples of a dye for a magenta toner include the following.

Oil-soluble dyes such as C. I. Solvent Red 1, 3, 8, 23, 24, 25, 27, 30, 49, 81, 82, 83, 84, 100, 109, 121; C. I. Disperse Red 9; C. I. Solvent Violet 8, 13, 14, 21, 27; C. I.

Disperse Violet 1, Basic dyes such as C. I. Basic Red 1, 2, 9, 12, 13, 14, 15, 17, 18, 22, 23, 24, 27, 29, 32, 34, 35, 36, 37, 38, 39, 40; C. I. Basic Violet 1, 3, 7, 10, 14, 15, 21, 25, 26, 27, 28.

Examples of a pigment for a cyan toner include the following.

C. I. Pigment Blue 2, 3, 15:2, 15:3, 15:4, 16, 17; C. I. Vat Blue 6; C. I. Acid Blue 45, a copper phthalocyanine pigment having a phthalocyanine skeleton substituted with 1 to 5 phthalimidomethyl groups.

Examples of a dye for a cyan toner include C. I. Solvent Blue 70.

Examples of a pigment for a yellow toner include the following.

C. I. Pigment Yellow 1, 2, 3, 4, 5, 6, 7, 10, 11, 12, 13, 14, 15, 16, 17, 23, 62, 65, 73, 74, 83, 93, 94, 95, 97, 109, 110, 111, 120, 127, 128, 129, 147, 151, 154, 155, 168, 174, 175, 176, 180, 181, 185; C. I. Vat Yellow 1, 3, 20.

Examples of a dye for a yellow toner include C. I. Solvent Yellow 162.

The content of the colorant is preferably 0.1 parts by mass to 30.0 parts by mass per 100 parts by mass of the binder resin.

The toner particle preferably contains a wax. Examples of the wax include those listed below. Hydrocarbon-based waxes such as microcrystalline waxes, paraffin waxes and Fischer Tropsch waxes; oxides of hydrocarbon-based waxes, such as oxidized polyethylene waxes, and block copolymers thereof; waxes comprising mainly fatty acid esters, such as carnauba wax; and waxes obtained by partially or wholly deoxidizing fatty acid esters, such as deoxidized carnauba wax.

Further examples include the types listed below. Saturated straight chain fatty acids such as palmitic acid, stearic acid and montanic acid; unsaturated fatty acids such as brassidic acid, eleostearic acid and parinaric acid; saturated alcohols such as stearyl alcohol, aralkyl alcohols, behenyl alcohol, carnaubyl alcohol, ceryl alcohol and melissyl alcohol; polyhydric alcohols such as sorbitol; esters of fatty acids such as palmitic acid, stearic acid, behenic acid and montanic acid and alcohols such as stearyl alcohol, aralkyl alcohols, behenyl alcohol, carnaubyl alcohol, ceryl alcohol and melissyl alcohol; fatty acid amides such as linoleic acid amide, oleic acid amide and lauric acid amide; saturated fatty acid bisamides such as methylene bis-stearic acid amide, ethylene bis-capric acid amide, ethylene bis-lauric acid amide and hexamethylene bis-stearic acid amide; unsaturated fatty acid amides such as ethylene bis-oleic acid amide, hexamethylene bis-oleic acid amide, N,N′-dioleyladipic acid amide and N,N′-dioleylsebacic acid amide; aromatic bisamides such as m-xylene bis-stearic acid amide and N,N′-distearylisophthalic acid; fatty acid metal salts (commonly known as metal soaps) such as calcium stearate, calcium laurate, zinc stearate and magnesium stearate; waxes obtained by grafting vinyl monomers such as styrene and acrylic acid onto aliphatic hydrocarbon-based waxes; partial esters of fatty acids and polyhydric alcohols, such as behenic acid monoglyceride; and hydroxyl group-containing methyl ester compounds obtained by hydrogenating plant-based oils and fats.

The content of the wax is preferably 2.0 to 30.0 parts by mass relative to 100 parts by mass of the binder resin.

The toner particle may contain a charge control agent if necessary. A well-known charge control agent can be used, but an aromatic carboxylic acid metal compound is particularly preferred from the perspectives of being colorless, toner charging speed being rapid, and being able to stably maintain a certain degree of charge quantity.

Examples of negative type charge control agents include metal salicylate compounds, metal naphthoate compounds, metal dicarboxylate compounds, polymer type compounds having a sulfonic acid or carboxylic acid in a side chain, polymer type compounds having a sulfonic acid salt or sulfonic acid ester in a side chain, polymer type compounds having a carboxylic acid salt or carboxylic acid ester in a side chain, boron compounds, urea compounds, silicon compounds and calixarenes.

The charge control agent may be internally or externally added to the toner particle. The content of the charge control agent is preferably 0.2 to 10.0 parts by mass relative to 100 parts by mass of the binder resin.

The toner may contain a toner particle and an external additive. As the external additive, inorganic fine particles such as silica, titanium oxide, aluminum oxide, and metal titanate are preferable. The inorganic fine particles are preferably hydrophobized with a hydrophobizing agent such as a silane compound, silicone oil, or a mixture thereof.

As the external additive for improving flowability, inorganic fine particles having a specific surface area from 50 m²/g to 400 m²/g are preferable, and for stabilizing durability, inorganic fine particles having a specific surface area from 10 m²/g to 50 m²/g are preferable. In order to achieve both improved flowability and stabilized durability, inorganic fine particles having a specific surface area within the above range may be used in combination. The toner particles and the external additive may be mixed using a known mixer such as a Henschel mixer.

The content of the external additive is preferably 0.1 parts by mass to 10.0 parts by mass, and more preferably 0.5 parts by mass to 5.0 parts by mass based on 100 parts by mass of the toner particles.

The toner can be used as a one-component developer, but is preferably mixed with a magnetic carrier and used as a two-component developer, in terms of obtaining stable images over long periods of time. Specifically, the developer is herein a two-component developer containing a toner and a magnetic carrier, such that the toner is the above-described toner.

Examples of magnetic carriers include generally known ones such as an iron powder or a surface-oxidized iron powder; metal particles of iron, lithium, calcium, magnesium, nickel, copper, zinc, cobalt, manganese, chromium, rare earths or the like, as well as alloy particles thereof and oxide particles thereof; magnetic bodies such as ferrite; and magnetic body-dispersed resin carriers (so-called resin carriers) containing one such magnetic body and a binder resin that holds the magnetic body in a dispersed state.

In a case where the toner is mixed with a magnetic carrier and used as a two-component developer, the content ratio of the toner in the two-component developer is preferably from 2 mass % to 15 mass %, more preferably from 4 mass % to 13 mass %.

The method for producing a toner particle is not particularly limited, and conventionally known production methods such as a suspension polymerization method, an emulsion aggregation method, a melt-kneading method or a dissolution suspension method can be resorted to.

A melt-kneading method will be explained below as an example, but the method is not limited thereto.

First, in the raw material mixing step, a binder resin containing a crystalline vinyl resin and, if necessary, an amorphous resin, inorganic fine particles, and, if necessary, other components such as wax, colorant, charge control agent, and the like are weighed out in predetermined amounts and blended, and mixed as the materials constituting the toner particles. Examples of mixing devices include double-con mixers, V-type mixer, drum mixers, Super mixer, Henschel mixer, Nauta mixer, and Mechano-Hybrid (manufactured by Nippon Coke & Engineering Co., Ltd.).

Next, the mixed materials are melted and kneaded to disperse the inorganic fine particles and other components in the binder resin containing the crystalline vinyl resin. In the melt kneading step, a batch type kneader such as a pressure kneader or a Banbury mixer, or a continuous type kneader can be used, and single-screw or twin-screw extruders are mainly used because they advantageously enable continuous production. Examples of such extruders include a KTK type twin screw extruder (manufactured by Kobe Steel, Ltd.), a TEM type twin screw extruder (manufactured by Toshiba Machine Co., Ltd.), a PCM kneader (manufactured by Ikegai Iron Works Co., Ltd.), a twin screw extruder (manufactured by KCK Corporation), a Co-Kneader (manufactured by Buss Co., Ltd.), and a Kneadex (manufactured by Nippon Coke and Engineering Co., Ltd.). Furthermore, the resin composition obtained by melt kneading may be rolled with a two-roll mill or the like and cooled with water or the like in a cooling step.

The cooled resin composition is then pulverized to a desired particle diameter in a pulverization step. In the pulverization step, the resin composition may be coarsely pulverized with a pulverizer such as a crusher, a hammer mill, or a feather mill, and then finely pulverized with a fine pulverizer using, for example, Cryptron System (manufactured by Kawasaki Heavy Industries, Ltd.), Super Rotor (manufactured by Nisshin Engineering Co., Ltd.), Turbo Mill (manufactured by Turbo Kogyo Co., Ltd.), or an air jet system.

Then, as necessary, classification may be performed using a classifier or sieve such as inertial classification type Elbow Jet (manufactured by Nittetsu Mining Co., Ltd.), centrifugal classification type Turboplex (manufactured by Hosokawa Micron Corporation), TSP Separator (manufactured by Hosokawa Micron Corporation), or Faculty (manufactured by Hosokawa Micron Corporation) to obtain toner particles.

A binder resin may be obtained in advance, before producing the toner, by crosslinking the amorphous resin with a polymerization initiator while kneading a mixture of a crystalline vinyl resin and an uncrosslinked amorphous resin. A binder resin may be also obtained by dissolving a crystalline vinyl resin and an uncrosslinked amorphous resin in a solvent, adding a polymerization initiator while stirring the system in which the two resins are present, and carrying out a crosslinking reaction. This method makes it easy to finely disperse the amorphous resin in the crystalline vinyl resin. It is preferable to obtain a binder resin by crosslinking the amorphous resin with a polymerization initiator while kneading a mixture of a crystalline vinyl resin and an uncrosslinked amorphous resin. That is, it is preferable that the amorphous resin be crosslinked.

From the viewpoint of performing the crosslinking, when the amorphous resin contains a polyester resin, it is preferable that the polyester resin have a structure corresponding to the above-mentioned bireactive compound such as fumaric acid.

Methods for measuring various physical properties of the toner and raw materials are explained below.

### Method for Identifying Monomer Units Constituting Binder Resin and Measuring Content Ratios of Monomer Units

The identification of the monomer units constituting the crystalline vinyl resin and the amorphous resin and the measurement of the content ratios of monomer units are performed by ¹H-NMR under the following conditions.
Measurement device: FT NMR device JNM-EX400 (manufactured by JEOL Ltd.)
Measurement frequency: 400 MHz
Pulse condition: 5.0 s
Frequency range: 10500 Hz
Number of times of accumulation: 64
Measurement temperature: 30° C.
Sample: 50 mg of the measurement sample is placed in a sample tube with an inner diameter of 5 mm, deuterated chloroform (CDCl₃) is added as a solvent, and this is dissolved in a thermostatic bath at 40° C. to prepare the sample.

The measurement sample can be any resin, such as crystalline vinyl resin, fractionated by the method described below.

The following is an explanation based on an example in which a crystalline vinyl resin is used. From among the peaks attributed to the components of the monomer unit represented by formula (1), which is contained in the crystalline vinyl resin, in the obtained ¹H-NMR chart, a peak that is independent of the peaks that are attributed to the components of other monomer unit is selected, and the integral value S₁ of this peak is calculated.

Similarly, the integral value S₂ is calculated for the other monomer unit contained in the crystalline vinyl resin.

For example, when the monomer units constituting the crystalline vinyl resin are the monomer unit represented by formula (1) and one other monomer unit, the content ratio of the monomer unit represented by formula (1) is obtained in the following manner by using the integral values S₁ and S₂. Here, n₁ and n₂ are the numbers of hydrogen atoms in the components to which the peaks of interest are attributed in respective segments.

$$Content ratio ( mol \% ) of the monomer unit represented by formula ( 1 ) = \{ ( {S}_{1} / {n}_{1} ) / ( ( {S}_{1} / {n}_{1} ) + ( {S}_{2} / {n}_{2} ) ) \} \times 100$$

$$Content ratio ( mol \% ) of other monomer unit = \{ ( {S}_{2} / {n}_{2} ) / ( ( {S}_{1} / {n}_{1} ) + ( {S}_{2} / {n}_{2} ) ) \} \times 100$$

Even when there are two or more other monomer units, the content ratio of the monomer units can be calculated in the same manner (using S₃ . . . Sₓ, n₃ . . . nₓ).

The content ratio of each monomer unit in the amorphous resin can be calculated in the same way.

When a polymerizable monomer that does not contain hydrogen atoms in the components other than the vinyl group is used, ¹³C-NMR is used with ¹³C as the measurement nucleus, the measurement is performed in a single pulse mode, and the calculation is performed in the same way as in the case of ¹H-NMR.

The mole percent can be converted to percent by mass based on the molecular weight of the monomer unit.

The number of carbon atoms in the alkyl groups such as R⁵ in formula (1) can be calculated from the integral ratio of the proton peak in the ¹H-NMR chart.

### Method for Measuring the Weight-Average Molecular Weight (Mw) of Resins etc. by Gel Permeation Chromatography (GPC)

The weight-average molecular weight (Mw) of tetrahydrofuran (THF)-soluble matter such as resins is measured as follows by permeation chromatography (GPC).

Firstly, a sample is dissolved in tetrahydrofuran (THF) over 24 hours at room temperature. The obtained solution is then filtered through a solvent-resistant membrane filter “MYSYORI DISC” (by Tosoh Corporation) having a pore diameter of 0.2 μm, to yield a sample solution. The sample solution is adjusted so that the concentration of the component soluble in THF is about 0.8 mass %. This sample solution is then used for measurements under the following conditions.
Device: HLC8220 GPC (detector: RI) (by Tosoh Corporation)
Column: 7 columns Shodex KF-801, 802, 803, 804, 805, 806 and 807 (by Showa Denko KK)
Eluent: tetrahydrofuran (THF)
Flow rate: 1.0 mL/min
Oven temperature: 40.0° C.
Sample injection volume: 0.10 mL

To calculate the molecular weight of the sample there is used a molecular weight calibration curve created using a standard polystyrene resin (product name “TSK STANDARD POLYSTYRENE F-850, F-450, F-288, F-128, F-80, F-40, F-20, F-10, F-4, F-2, F-1, A-5000, A-2500, A-1000 or A-500”, by Tosoh Corporation).

### Method for Measuring Weight-average Particle Diameter (D4) of Toner (Toner Particle)

The weight-average particle diameter (D4) of the toner (toner particle) is calculated by carrying out measurements using a precision particle size distribution measuring device which employees a pore electrical resistance method and uses a 100 m aperture tube (“Coulter Counter Multisizer 3” (registered trademark) available from Beckman Coulter) and accompanying dedicated software that is used to set measurement conditions and analyze measured data (“Beckman Coulter Multisizer 3 Version 3.51 produced by Beckman Coulter) (no. of effective measurement channels: 25,000), and then analyzing the measurement data.

A solution obtained by dissolving special grade sodium chloride in ion exchanged water at a concentration of approximately 1 mass %, such as “ISOTON II” (produced by Beckman Coulter), can be used as an aqueous electrolyte solution used in the measurements. Moreover, the dedicated software was set up as follows before carrying out measurements and analysis.

On the “Standard Operating Method (SOM) alteration screen” in the dedicated software, the total count number in control mode is set to 50,000 particles, the number of measurements is set to 1, and the Kd value is set to “standard particle 10.0 μm” (Beckman Coulter). By pressing the threshold value/noise level measurement button, threshold values and noise levels are automatically set. In addition, the current is set to 1600 μA, the gain is set to 2, the electrolyte solution is set to ISOTON II, and the “Flush aperture tube after measurement” option is checked. On the “Screen for converting from pulse to particle diameter” in the dedicated software, the bin interval is set to logarithmic particle diameter, the particle diameter bin is set to 256 particle diameter bin, and the particle diameter range is set to from 2 μm to 60 μm. The specific measurement method is as follows.
(1) 200 mL of the aqueous electrolyte solution is placed in a dedicated Multisizer 3 250 mL glass round bottomed beaker, the beaker is set on a sample stand, and a stirring rod is rotated anticlockwise at a rate of 24 rotations/second. By carrying out the “Aperture tube flush” function of the dedicated software, dirt and bubbles in the aperture tube are removed.
(2) 30 mL of the aqueous electrolyte solution is placed in a 100 mL glass flat bottomed beaker, and approximately 0.3 mL of a diluted liquid, which is obtained by diluting “Contaminon N” (a 10 mass % aqueous solution of a neutral detergent for cleaning precision measurement equipment, which has a pH of 7 and comprises a non-ionic surfactant, an anionic surfactant and an organic builder, available from Wako Pure Chemical Industries, Ltd.) 3-fold with ion exchanged water, is added to the beaker as a dispersing agent.
(3) A prescribed amount of ion exchanged water is placed in a water bath of an “Ultrasonic Dispersion System Tetora 150” (available from Nikkaki Bios Co., Ltd.) having an electrical output of 120 W, in which 2 oscillators having an oscillation frequency of 50 kHz are housed so that their phases are staggered by 180°, and approximately 2 mL of the Contaminon N is added to the water bath.
(4) The beaker used in step (2) above is placed in a beaker-fixing hole in the ultrasonic wave disperser, and the ultrasonic wave disperser is activated. The height of the beaker is adjusted so that the resonant state of the liquid surface of the aqueous electrolyte solution in the beaker is at a maximum.
(5) While the aqueous electrolyte solution in the beaker mentioned in section (4) above is being irradiated with ultrasonic waves, approximately 10 mg of toner particles are added a little at a time to the aqueous electrolyte solution and dispersed therein. The ultrasonic wave dispersion treatment is continued for a further 60 seconds. Moreover, when carrying out the ultrasonic wave dispersion, the temperature of the water bath is adjusted as appropriate to a temperature of from 10° C. to 40° C.
(6) The aqueous electrolyte solution mentioned in section (5) above, in which the toner (toner particle) is dispersed, is added dropwise by means of a pipette to the round bottomed beaker mentioned in section (1) above, which is disposed on the sample stand, and the measurement concentration is adjusted to approximately 5%. Measurements are carried out until the number of particles measured reaches 50,000.
(7) The weight average particle diameter (D4) is calculated by analyzing measurement data using the accompanying dedicated software. Moreover, when setting the graph/vol. % with the dedicated software, the “average diameter” on the analysis/volume-based statistical values (arithmetic mean) screen is weight average particle diameter (D4).

### Method for Measuring Melting Point of Crystalline Vinyl Resin; Peak Top Tm

The melting point of crystalline vinyl resin is measured using a DSC Q1000 (manufactured by TA Instruments) under the following conditions.
Heating rate: 10° C./min
Measurement start temperature: 20° C.
Measurement end temperature: 180° C.

The melting points of indium and zinc are used to correct the temperature of the detection unit of the device, and the heat of fusion of indium is used to correct the amount of heat.

Specifically, 5 mg of the sample is precisely weighed and placed in an aluminum pan, and differential scanning calorimetry is performed. An empty silver pan is used as a reference.

The peak temperature of the maximum endothermic peak in the first temperature rise process is taken as the melting point of the crystalline vinyl resin and considered as peak top Tm.

When there are multiple peaks, the maximum endothermic peak is the peak with the largest amount of endothermic heat.

### Cross-Sectional Observation of a Toner

Firstly, a thin piece is produced as a reference sample of abundance.

The crystalline resin is thoroughly dispersed in a visible-light curable resin (product name: Aronix LCR series D-800), followed by curing through irradiation with-short-wavelength light. The obtained cured product is cut out with an ultramicrotome equipped with a diamond knife, to produce a 250 nm flaky sample. A flaky sample of the amorphous resin is prepared in the same manner.

The crystalline resin and the amorphous resin are mixed at 0/100, 30/70, 70/30 and 0/100, on a mass basis, and the mixtures are melt-kneaded, to yield kneaded products. These products are similarly dispersed in a visible light-curable resin, are cured, and are then cut out to thereby prepare flaky samples.

Cross sections of these cut reference samples are observed using a transmission electron microscope (electron microscope JEM-2800, by JEOL Ltd.) (TEM-EDX), and element mapping is performed by EDX. The elements to be mapped herein are carbon, oxygen and nitrogen.

Mapping conditions are as follows.
Acceleration voltage: 200 kV
Electron beam irradiation size: 1.5 nm
Live time limit: 600 sec
Dead time: 20-30
Mapping resolution: 256×256

Ratios of (oxygen intensity/carbon intensity) and (nitrogen intensity/carbon intensity) are calculated on the basis of the spectral intensity (average in a 10 nm square area) of each element, to prepare respective calibration curves relative to the mass ratios of the crystalline resin and amorphous resin. In the case where the monomer units of the crystalline resin contain nitrogen atoms, the calibration curve of (nitrogen intensity/carbon intensity) is resorted to in a further quantification.

Each toner sample is then analyzed.

After the toner has been sufficiently dispersed in a visible-light curable resin (Aronix LCR, series D-800), the resin is cured through irradiation with short-wavelength light. The resulting cured product is cut with an ultramicrotome equipped with a diamond knife, to produce a 250 nm flaky sample.

The cut sample is then observed using a transmission electron microscope (electron microscope JEM-2800 by JEOL Ltd.) (TEM-EDX). A toner particle cross-sectional image is obtained, and elemental mapping is performed by EDX.

The elements to be mapped are carbon, oxygen, nitrogen, silicon, calcium, titanium, strontium, and copper.

### Method for Measuring Primary Particle Diameter of Inorganic Fine Particles in Toner Particle

The particles are identified from the element mapping obtained by the above-mentioned cross-sectional observation of the toner from the elements that compose the inorganic fine particles, and then the area occupied by the inorganic fine particles in the toner cross section is calculated by binarization processing. The toner particles for determining the number-average diameter of the primary particles of the inorganic fine particles are selected by obtaining circle-equivalent diameters from the cross-sectional area in a micrograph and selecting the particles for which this value is within ±10% of the weight-average particle diameter (D4) obtained by the above-mentioned method using the Coulter counter. The number-average diameter of the primary particles of the inorganic fine particles is calculated from the circle-equivalent diameter of the region occupied by the inorganic fine particles. In order to eliminate the influence of external additives, the inorganic fine particles present inside the outline of the toner particles are measured. In addition, 100 primary particles are randomly selected and measured.

Image Pro PLUS (manufactured by Nippon Roper Co., Ltd.) is used for the binarization process and calculation of the area ratio.

Method for Confirming Whether all Inorganic Fine Particles are Enclosed in Region that is 0.3 μm or More Inside from Toner Particle Surface

The cross section of the toner particle is observed from the observation sample prepared in the same manner as in the method for measuring the number-average diameter of the primary particles of the inorganic fine particles described above, and a photograph is taken at a magnification 10000 to 20000 times according to the particle diameter of the toner particle. In this magnified photograph, the area occupied by the inorganic fine particles is converted from the brightness difference into binary image data using image analysis software Image-ProPlus5.1J (manufactured by Media Cybernetics Co., Ltd.). Since the object to be measured is a toner particle, the inside of the outline of the toner particle is measured.

In the converted image, a position at 0.3 μm from the surface of the toner particle (i.e., from the outline of the cross section of the toner particle) is identified. Then, the areas occupied by the inorganic fine particles located 0.3 μm or more inside from the surface of the toner particle is calculated.

From these areas, the content A (% by mass) of inorganic fine particles located 0.3 μm or more inside from the surface of the toner particle, and the content B (% by mass) of inorganic fine particles present to a depth of 0.3 μm from the surface of the toner particle are calculated using the density of the binder resin, inorganic fine particles, and pigment, as well as the number-average diameter of the inorganic fine particles. For inorganic fine particles present across a boundary at 0.3 μm inside from the surface of the toner particle, the calculation is performed by dividing the area at the boundary and counting each divided area. When the relationship between these contents is in the range of A/(A+B)×100≥80, it is determined that “the inorganic fine particles are contained in the region that is 0.3 μm or more inside from the surface of the toner particle”. The value obtained by calculation of A/(A+B)×100 is from the observation of 100 cross sections of toner particles.

Method for Separating Toner Particles from Toner

When analyzing toner particles, where the surface of the toner particles has been treated with an external additive, the external additive is separated by the following method to obtain toner particles.

A total of 160 g of sucrose (manufactured by Kishida Chemical Co., Ltd.) is added to 100 mL of ion-exchanged water and dissolved using a hot water bath to prepare a concentrated sucrose solution. A total of 31 g of the concentrated sucrose solution and 6 mL of Contaminon N (a 10% aqueous solution of a neutral detergent for cleaning precision measuring instruments that has pH 7 and consists of a nonionic surfactant, an anionic surfactant, and an organic builder, manufactured by Wako Pure Chemical Industries, Ltd.) are added to a centrifuge tube to prepare a dispersion liquid.

A total of 1.0 g of toner is added to this dispersion, and the toner lumps are broken with a spatula or the like. The centrifuge tube is shaken with a shaker (AS-1N, sold by AS ONE Corporation) at 350 spm (strokes per minute) for 20 min. After shaking, the solution is transferred to a glass tube for a swing rotor (50 mL) and separated in a centrifuge (H-9R, manufactured by Kokusan Co., Ltd.) at 3500 rpm for 30 min. This operation separates the toner particles from the removed external additives.

The separation of toner particles and the aqueous solution is visually confirmed to be sufficient, and the toner particles separated in the top layer are collected with a spatula or the like. The collected toner is filtered through a vacuum filter and then dried in a dryer for 1 h or more to obtain toner particles. This operation is carried out multiple times to ensure the required amount.

Method for Separating Each Material from Toner Particle

Materials can be separated from the toner particle by utilizing the difference in solubility of each material contained in the toner particle in a solvent.

First separation: the toner is dissolved in methyl ethyl ketone (MEK) at 23° C., and the soluble matter (amorphous resin) and the insoluble matter (crystalline vinyl resin, wax, colorant, inorganic fine particles, and the like) are separated.

Second separation: the insoluble matter obtained in the first separation (crystalline vinyl resin, wax, colorant, inorganic fine particles, and the like) is dissolved in MEK at 100° C., and the soluble matter (crystalline vinyl resin, wax) and the insoluble matter (colorant, inorganic fine particles, and the like) are separated.

Third separation: the soluble matter obtained in the second separation (crystalline vinyl resin, wax) is dissolved in chloroform at 23° C., and the soluble matter (crystalline vinyl resin) and the insoluble matter (wax) are separated.

Fourth separation: the insoluble matter obtained in the second separation is dispersed in tetrahydrofuran, and by changing the centrifugal force in the centrifugation method, the inorganic fine particles (for example, calcium carbonate) and the colorant are separated based on the difference in specific gravity.

### When Third Resin is Further Included in Addition to Crystalline Vinyl Resin and Amorphous Resin

First separation: toner particles are dissolved in methyl ethyl ketone (MEK) at 23° C., and the soluble matter (amorphous resin, third resin) and the insoluble matter (crystalline vinyl resin, wax, colorant, inorganic fine particles, and the like) are separated.

Second separation: the soluble matter (amorphous resin, third resin) obtained in the first separation is dissolved in toluene at 23° C., and the soluble matter (third resin) and the insoluble matter (amorphous resin) are separated.

Third separation: the insoluble matter (crystalline vinyl resin, wax, colorant, inorganic fine particles, and the like) obtained in the first separation is dissolved in MEK at 100° C., and the soluble matter (crystalline vinyl resin, wax) and the insoluble matter (colorant, inorganic fine particles, and the like) are separated.

Fourth separation: the soluble matter (crystalline vinyl resin, wax) obtained in the third separation is dissolved in chloroform at 23° C., and the soluble matter (crystalline vinyl resin) and the insoluble matter (wax) are separated.

Fifth separation: the insoluble matter obtained in the third separation is dispersed in tetrahydrofuran, and the inorganic fine particles and the colorant are separated based on the difference in specific gravity by changing the centrifugal force in the centrifugation method.

### Measurement of Content of Inorganic Fine Particles Based on Mass of Toner Particle

In the above-described method for separating each material from the toner particle, the mass of the inorganic fine particles obtained in the fourth or fifth separation is divided by the mass of the toner particle to measure the content of the inorganic fine particles based on the mass of the toner particle.

### Measurement of Content of Crystalline Vinyl Resin in Toner Particle

In the method for separating each material from the toner particle, the mass of the crystalline vinyl resin obtained in the third or fourth separation is divided by the mass of the toner particle to measure the content of the crystalline vinyl resin in the toner particle.

### Structural Analysis of Surface Treatment Agent for Inorganic Fine Particles

The structure is analyzed using a pyrolysis gas chromatography mass spectrometer (GC/MS) in the following manner. A total of 300 g of calcium carbonate separated from toner particles by the above-mentioned method is embedded in the following Pyrofoil F590 and introduced into a pyrolysis furnace and heated at 590° C. for 5 sec in an inert (helium) atmosphere. The generated decomposition gas is introduced into the gas chromatograph inlet, and the following oven profile is performed. The column outlet is connected to an MS analyzer by a transfer line, and a total ion chromatogram (TIC) is obtained in which the ion current plotted on the vertical axis and the retention time is plotted on the horizontal axis. Next, mass spectra are extracted using the provided software for all peaks detected in the obtained chromatogram, and the compounds are attributed based on the NIST-2017 database.

### Measurement of Amount of Surface Treatment Agent on Inorganic Fine Particles

The amount of surface treatment agent on the inorganic fine particles separated from the toner particle by the above method is measured using a thermogravimetric/differential thermal analyzer (differential thermal balance TG-DTA, ThermoPlusTG8120, manufactured by Rigaku Corporation). The temperature is raised from 25° C. to 400° C. at a rate of 10° C./min, the measured weight change is converted to the percent by mass of the alkyl groups that reacted in the combustion reaction using the molecular formula determined by structural analysis of the surface treatment agent, and the content of the alkyl groups on the surface of the inorganic fine particles is calculated.

### EXAMPLES

The present disclosure will now be explained in greater detail using the working examples given below. However, these working examples in no way limit the present disclosure. In the formulations below, “parts” always means parts by mass unless explicitly indicated otherwise.

### Production Example of Monomer 1 Capable of Forming Monomer Unit Represented by Formula (1)

The following materials were placed in a reaction vessel equipped with a reflux condenser, a stirrer, a thermometer, and a nitrogen introduction tube under a nitrogen atmosphere.

| | | |
|---|---|---|
| Behenyl alcohol | 883 | parts |
| (66 mol % relative to the total number | | |
| of moles of alcohol and carboxylic acid) | | |
| Fumaric acid | 164 | parts |
| (34 mol % relative to the total number of moles | | |
| of alcohol and carboxylic acid) | | |
| Dibutyltin oxide | 2.5 | parts |
| 2,6-Di-tert-butyl-p-cresol | 1.0 | parts |

Next, the atmosphere in a flask was replaced with nitrogen gas, the temperature was gradually raised while stirring, and the mixture was homogenized at 120° C. by stirring. The temperature was then raised to 165° C., and the mixture was esterified under reduced pressure at 21 kPa for 3 h, while removing the distillate, and then esterified under reduced pressure at 21 kPa for 3 h by removing the distillate to obtain monomer 1.

### Production Examples of Monomers 2 to 10

The reaction was carried out in the same manner as in the production example of monomer 1, except that the raw material mixture was changed to those shown in Table 1, and monomers 2 to 10 were obtained.

TABLE 1

| Monomer | First alcohol | | | Second alcohol | | | Carboxylic acid | |
|---|---|---|---|---|---|---|---|---|
| No. | Alcohol | C | mol % | Alcohol | C | mol % | Carboxylic acid | mol % |
| 1 | Behenyl alcohol | 22 | 66 | — | — | — | Fumaric acid | 34 |
| 2 | Behenyl alcohol | 22 | 33 | Stearyl alcohol | 18 | 33 | Fumaric acid | 34 |
| 3 | Cetanol | 16 | 66 | — | — | — | Fumaric acid | 34 |
| 4 | 1-Tetracosanol | 24 | 66 | — | — | — | Fumaric acid | 34 |
| 5 | Behenyl alcohol | 22 | 66 | — | — | — | Methylenemalonic | 34 |
| | | | | | | | acid | |
| 6 | Behenyl alcohol | 22 | 66 | — | — | — | Itaconic acid | 34 |
| 7 | Myricyl alcohol | 30 | 66 | — | — | — | Fumaric acid | 34 |
| 8 | Behenyl alcohol | 22 | 66 | — | — | — | Acrylic acid | 34 |
| 9 | 1-Tetradecanol | 14 | 66 | — | — | — | Fumaric acid | 34 |
| 10 | CH₃(CH₂)₃₁OH | 32 | 66 | — | — | — | Fumaric acid | 34 |

In the table, C indicates the number of carbon atoms when each monomer corresponds to R⁵ in formula (1).

### Production Example of Crystalline Vinyl Resin 1

| | |
|---|---|
| Solvent: toluene | 100.0 parts |
| Monomer composition | 100.0 parts |

(The monomer composition is a mixture of monomer 1, acrylonitrile, methyl acrylate, and styrene in the ratios shown below.)
[Monomer 1: 60.0 parts]
[Acrylonitrile: 20.0 parts]
[Methyl acrylate: 1.0 part]
[Styrene: 19.0 parts]
Polymerization initiator: 0.5 parts
[t-Butyl peroxypivalate (Perbutyl PV, manufactured by NOF Corp.)]

The above materials were placed in a reaction vessel equipped with a reflux condenser, a stirrer, a thermometer, and a nitrogen introduction tube under a nitrogen atmosphere. The inside of the reaction vessel was heated to 70° C. while stirring at 200 rpm, and a polymerization reaction was carried out for 12 h, yielding a solution in which the polymer of the monomer composition was dissolved in toluene.

The solution temperature was then lowered to 25° C., and the solution was then poured into 1000.0 parts of methanol while stirring to precipitate a methanol insoluble matter. The resulting methanol insoluble matter was filtered off, washed with methanol, and then vacuum dried at 40° C. for 24 h to obtain crystalline vinyl resin 1. The physical properties are shown in Table 3.

### Production Example of Crystalline Vinyl Resins 2 to 15

The reaction was carried out in the same manner as in the production example of crystalline vinyl resin 1, except that the monomers and parts by mass were changed as shown in Table 2, to obtain crystalline vinyl resins 2 to 15. The physical properties are shown in Table 3.

When using fumaric acid selected as the carboxylic acid as a monomer shown in Table 1, a crystalline vinyl resin containing a monomer unit in which either R¹ or R² and either R³ or R⁴ in formula (1) are —COOR⁵ is obtained. When methylenemalonic acid is selected as the monomer, a vinyl resin containing a monomer unit in which R¹ and R² (or R³ and R⁴) are —COOR⁵ is obtained. When itaconic acid is selected as the monomer, a vinyl resin containing a monomer unit in which either R¹ or R² (or either R³ or R⁴) is —X—COOR⁵ (X is a methylene group with one carbon atom) and the other is —COOR⁵ is obtained. When acrylic acid is selected, a crystalline vinyl resin containing a monomer unit in which at least one of R¹, R², R³, and R⁴ is —COOR⁵ is obtained.

TABLE 2

| | Monomer capable of | | Second | | | | | |
|---|---|---|---|---|---|---|---|---|
| Crystalline | forming monomer unit | | polymerizable | | Third polymerizable | | Fourth polymerizable | |
| vinyl resin | of formula (1) | | monomer | | monomer | | monomer | |
| No. | Monomer | Parts | Type | Parts | Type | Parts | Type | Parts |
| 1 | Monomer 1 | 60.0 | Acrylonitrile | 20.0 | Methyl acrylate | 1.0 | Styrene | 19.0 |
| 2 | Monomer 2 | 60.0 | Acrylonitrile | 20.0 | Methyl acrylate | 1.0 | Styrene | 19.0 |
| 3 | Monomer 3 | 60.0 | Acrylonitrile | 20.0 | Methyl acrylate | 1.0 | Styrene | 19.0 |
| 4 | Monomer 4 | 60.0 | Acrylonitrile | 20.0 | Methyl acrylate | 1.0 | Styrene | 19.0 |
| 5 | Monomer 1 | 35.0 | Acrylonitrile | 20.0 | Styrene | 25.0 | Methacrylonitrile | 20.0 |
| 6 | Monomer 1 | 28.0 | Acrylonitrile | 20.0 | Styrene | 32.0 | Methacrylonitrile | 20.0 |
| 7 | Monomer 5 | 28.0 | Acrylonitrile | 20.0 | Styrene | 32.0 | Methacrylonitrile | 20.0 |
| 8 | Monomer 6 | 28.0 | Acrylonitrile | 20.0 | Styrene | 32.0 | Methacrylonitrile | 20.0 |
| 9 | Monomer 1 | 6.0 | Acrylonitrile | 20.0 | Methyl acrylate | 1.0 | Styrene | 73.0 |
| 10 | Monomer 7 | 60.0 | Acrylonitrile | 20.0 | Methyl acrylate | 1.0 | Styrene | 19.0 |
| 11 | Monomer 8 | 60.0 | Acrylonitrile | 20.0 | Styrene | 20.0 | — | — |
| 12 | Monomer 9 | 60.0 | Acrylonitrile | 20.0 | Methyl acrylate | 1.0 | Styrene | 19.0 |
| 13 | Monomer 10 | 60.0 | Acrylonitrile | 20.0 | Methyl acrylate | 1.0 | Styrene | 19.0 |
| 14 | Monomer 11 | 4.0 | Acrylonitrile | 20.0 | Methyl acrylate | 1.0 | Styrene | 75.0 |
| 15 | Monomer 1 | 60.0 | Acrylonitrile | 10.0 | Hydroxyethyl acrylate | 5.0 | Styrene | 15.0 |

TABLE 3

| | | Endothermic peak top Tm |
|---|---|---|
| Crystalline vinyl resin | Mw | [° C.] |
| Crystalline vinyl resin 1 | 20300 | 60 |
| Crystalline vinyl resin 2 | 22200 | 60 |
| Crystalline vinyl resin 3 | 19600 | 45 |
| Crystalline vinyl resin 4 | 20600 | 65 |
| Crystalline vinyl resin 5 | 21500 | 52 |
| Crystalline vinyl resin 6 | 20000 | 50 |
| Crystalline vinyl resin 7 | 22000 | 52 |
| Crystalline vinyl resin 8 | 20700 | 52 |
| Crystalline vinyl resin 9 | 20300 | 50 |
| Crystalline vinyl resin 10 | 22300 | 80 |
| Crystalline vinyl resin 11 | 20600 | 59 |
| Crystalline vinyl resin 12 | 20400 | 39 |
| Crystalline vinyl resin 13 | 22000 | 84 |
| Crystalline vinyl resin 14 | 20200 | 50 |
| Crystalline vinyl resin 15 | 20400 | 60 |

### Production Example of Amorphous Resin 1

The following materials were placed in a reaction vessel equipped with a reflux condenser, a stirrer, a thermometer, and a nitrogen introduction tube under a nitrogen atmosphere.
Terephthalic acid: 633 parts
Behenic acid: 31 parts
1,2-Propanediol: 173 parts
   (24.8 mol % relative to the total number of moles of polycarboxylic acids)
Neopentyl glycol: 251 parts
   (26.3 mol % relative to the total number of moles of polycarboxylic acids)
Titanium diisopropoxy bistriethanol aminate: 2.0 parts

The atmosphere in the flask was replaced with nitrogen gas, and the mixture was homogenized by stirring for 30 min. The temperature was then gradually raised, esterification was carried out under reduced pressure at 0.45 MPa and 227° C. for 5 h, followed by esterification under reduced pressure at 4 kPa or less, 161 parts of 1.2-propanediol was recovered, and after cooling to 180° C., 2 parts of 2.6-di-tert-butyl-4-methylphenol was added, followed by homogenization for 30 min. Then, 68 parts of fumaric acid was added, esterification under reduced pressure was carried out at 180° C. for 2 h, followed by esterification under reduced pressure at 4 kPa or less for 15 h, and the mixture was removed from the reaction vessel to obtain a polyester resin (amorphous resin 1).

### Production Example of Amorphous Resin 2

A total of 50.0 parts of xylene was charged into an autoclave, and after replacing the atmosphere in the autoclave with nitrogen, the temperature was raised to 185° C. in a sealed state while stirring.

A mixed solution of 37.0 parts of styrene, 20.0 parts of n-butyl acrylate, 3.0 parts of methyl methacrylate, 18.0 parts of methyl acrylate, 25.0 parts of acrylonitrile, and also 1.0 part of di-tert-butyl peroxide and 40.0 parts of xylene was continuously added dropwise to the autoclave for 3 h while controlling the temperature inside the autoclave at 190° C., and polymerization was carried out. The same temperature was maintained for another hour to complete the polymerization, and the solvent was removed to obtain amorphous resin 2.

### Production Example of Toner Particles 1

A total of 40 parts of amorphous resin 1 and 60 parts of crystalline vinyl resin 1 were mixed and homogenized at 170° C. in a reaction vessel equipped with a cooling tube, a stirrer, and a nitrogen introduction tube. Then, 2 parts of di-t-butyl peroxide was added, and a crosslinking reaction was carried out at 170° C. for 1 h. The pressure was then reduced under the conditions of 1.0 kPa in 2 h at 170° C., and decomposition products derived from the initiator were removed. The obtained material was coarsely pulverized to 1 mm or less using a hammer mill to obtain binder resin 1.

To 74.00 parts of this binder resin, 6.00 parts of cyan pigment (Pigment Blue 15:3), 10.00 parts of inorganic fine particles 1, and 10.00 parts of hydrocarbon wax were added and mixed using a Henschel mixer (FM-75, manufactured by Nippon Coke and Engineering Co., Ltd.) at a rotation speed of 20 s⁻¹ and a rotation time of 3 min. The obtained mixture was kneaded in a twin-screw kneader (PCM-30, manufactured by Ikegai Co., Ltd.) set at a temperature of 120° C., with a screw rotation speed of 250 rpm and a discharge temperature of 110° C.

The obtained kneaded material was cooled and coarsely pulverized to 1 mm or less using a hammer mill to obtain a coarsely pulverized material. The obtained coarsely pulverized material was finely pulverized using a mechanical pulverizer (T-250, manufactured by Freund Turbo Co., Ltd.). Further, classification was performed using Faculty F-300 (manufactured by Hosokawa Micron Corporation), and toner particles 1 with a weight-average particle diameter of 6.1 μm were obtained. The operating conditions were a classification rotor rotation speed of 130 s⁻¹ and a dispersion rotor rotation speed of 120 s⁻¹.

### Production Example of Toner Particles 2 to 47

Toner particles 2 to 34 and 36 to 47 were produced in the same manner as in the production example of toner particles 1, except that the types and numbers of parts of the crystalline vinyl resin, amorphous resin, and inorganic fine particles used were changed to those in Tables 4, 5, and 6.

For toner particles 35, inorganic fine particles 11 were not mixed in the mixing before kneading, and after classification, inorganic fine particles 11 were mixed in a Henschel mixer FM-10C (manufactured by Mitsui Miike Chemical Engineering Co., Ltd.) at a rotation speed of 70 s⁻¹ and a rotation time of 30 min, thereby obtaining toner particles 35.

TABLE 4

| | Crystalline vinyl | Parts by | Amorphous | Parts by |
|---|---|---|---|---|
| Binder resin | resin No. | mass | resin No. | mass |
| Binder resin 1 | 1 | 60 | 1 | 40 |
| Binder resin 2 | 2 | 60 | 1 | 40 |
| Binder resin 3 | 1 | 60 | 2 | 40 |
| Binder resin 4 | 2 | 60 | 2 | 40 |
| Binder resin 5 | 3 | 60 | 1 | 40 |
| Binder resin 6 | 4 | 60 | 1 | 40 |
| Binder resin 7 | 5 | 35 | 1 | 65 |
| Binder resin 8 | 6 | 35 | 1 | 65 |
| Binder resin 9 | 7 | 35 | 1 | 65 |
| Binder resin 10 | 8 | 35 | 1 | 65 |
| Binder resin 11 | 8 | 28 | 1 | 72 |
| Binder resin 12 | 8 | 78 | 1 | 22 |
| Binder resin 13 | 8 | 85 | 1 | 15 |
| Binder resin 14 | 9 | 60 | 1 | 40 |
| Binder resin 15 | 10 | 60 | 1 | 40 |
| Binder resin 16 | 1 | 60 | 1 | 40 |
| Binder resin 17 | 11 | 60 | 1 | 40 |
| Binder resin 18 | 12 | 60 | 1 | 40 |
| Binder resin 19 | 13 | 60 | 1 | 40 |
| Binder resin 20 | 14 | 60 | 1 | 40 |
| Binder resin 21 | 15 | 60 | 1 | 40 |

TABLE 5

| | | | | | | Number- |
|---|---|---|---|---|---|---|
| | | | | Number of | Content of | average |
| | | | | carbon | alkyl | diameter of |
| Inorganic | | | Functional group of | atoms in | groups | primary |
| fine particle | | Surface treatment | inorganic fine | surface alkyl | (% by | particles |
| No. | Composition | agent | particle surface | group | mass) | [nm] |
| 1 | Calcium carbonate | Stearic acid | Stearyl group | 18 | 2.00 | 200 |
| 2 | Calcium carbonate | Palmitic acid | Palmityl group | 16 | 2.00 | 200 |
| 3 | Calcium carbonate | Palmitic acid | Palmityl group | 16 | 3.00 | 200 |
| 4 | Calcium carbonate | Palmitic acid | Palmityl group | 16 | 4.00 | 200 |
| 5 | Calcium carbonate | Palmitic acid | Palmityl group | 16 | 0.15 | 200 |
| 6 | Calcium carbonate | Palmitic acid | Palmityl group | 16 | 0.05 | 200 |
| 7 | Calcium carbonate | Palmitic acid | Palmityl group | 16 | 4.80 | 200 |
| 8 | Calcium carbonate | Palmitic acid | Palmityl group | 16 | 5.50 | 200 |
| 9 | Calcium carbonate | Palmitic acid | Palmityl group | 16 | 5.50 | 450 |
| 10 | Calcium carbonate | Palmitic acid | Palmityl group | 16 | 5.50 | 550 |
| 11 | Calcium carbonate | Palmitic acid | Palmityl group | 16 | 4.00 | 550 |
| 12 | Strontium titanate | Isobutylsilane | Isobutyl group | 3 | 1.00 | 35 |
| 13 | Silica | D4 cyclic siloxane | Disiloxanyl group | 1 | 1.00 | 120 |
| 14 | Silica | Reactive silicone oil | Disiloxanyl group | 1 | 1.00 | 40 |
| 15 | Silica | D4 cyclic siloxane | Disiloxanyl group | 1 | 1.00 | 15 |
| 16 | Silica | D4 cyclic siloxane | Disiloxanyl group | 1 | 1.00 | 300 |

TABLE 6

| | Toner composition | | | | | | | | | | | | |
|---|---|---|---|---|---|---|---|---|---|---|---|---|---|
| | | | | | First inorganic | | Second | | | | | | |
| | | | | | fine particle: | | inorganic fine | | Third | | Fourth | | Hydro- |
| | Toner | Binder resin | | cyan | calcium | | particle: | | inorganic fine | | inorganic fine | | carbon |
| Toner | particle | Binder resin | | pigment | carbonate | | strontium titanate | | particle: silica | | particle: silica | | wax |
| No. | No. | No. | Parts | Parts | No. | Parts | No. | Parts | No. | Parts | No. | Parts | Parts |
| 1 | 1 | 1 | 74.00 | 6.00 | 1 | 10.00 | — | — | — | — | — | — | 10 |
| 2 | 2 | 2 | 74.00 | 6.00 | 1 | 10.00 | — | — | — | — | — | — | 10 |
| 3 | 3 | 3 | 74.00 | 6.00 | 1 | 10.00 | — | — | — | — | — | — | 10 |
| 4 | 4 | 4 | 74.00 | 6.00 | 1 | 10.00 | — | — | — | — | — | — | 10 |
| 5 | 5 | 5 | 74.00 | 6.00 | 1 | 10.00 | — | — | — | — | — | — | 10 |
| 6 | 6 | 6 | 74.00 | 6.00 | 1 | 10.00 | — | — | — | — | — | — | 10 |
| 7 | 7 | 1 | 74.00 | 6.00 | 2 | 10.00 | — | — | — | — | — | — | 10 |
| 8 | 8 | 1 | 83.00 | 6.00 | — | — | 12 | 1.00 | — | — | — | — | 10 |
| 9 | 9 | 1 | 83.00 | 6.00 | — | — | — | — | 13 | 1.00 | — | — | 10 |
| 10 | 10 | 1 | 83.00 | 6.00 | — | — | — | — | 14 | 1.00 | — | — | 10 |
| 11 | 11 | 1 | 83.00 | 6.00 | — | — | — | — | 15 | 1.00 | — | — | 10 |
| 12 | 12 | 1 | 74.00 | 6.00 | — | — | — | — | 15 | 1.00 | — | — | 10 |
| 13 | 13 | 1 | 83.00 | 6.00 | — | — | — | — | 16 | 1.00 | — | — | 10 |
| 14 | 14 | 1 | 74.00 | 6.00 | — | — | — | — | 16 | 10.00 | — | — | 10 |
| 15 | 15 | 1 | 83.24 | 6.00 | — | — | — | — | 13 | 0.38 | 14 | 0.38 | 10 |
| 16 | 16 | 1 | 83.81 | 6.00 | — | — | — | — | 13 | 0.10 | 14 | 0.10 | 10 |
| 17 | 17 | 1 | 73.24 | 6.00 | 1 | 10.00 | — | — | 13 | 0.38 | 14 | 0.38 | 10 |
| 18 | 18 | 1 | 73.81 | 6.00 | 1 | 10.00 | — | — | 13 | 0.10 | 14 | 0.10 | 10 |
| 19 | 19 | 7 | 71.00 | 6.00 | 3 | 13.00 | — | — | — | — | — | — | 10 |
| 20 | 20 | 7 | 71.00 | 6.00 | 4 | 13.00 | — | — | — | — | — | — | 10 |
| 21 | 21 | 7 | 71.00 | 6.00 | 5 | 13.00 | — | — | — | — | — | — | 10 |
| 22 | 22 | 7 | 71.00 | 6.00 | 6 | 13.00 | — | — | — | — | — | — | 10 |
| 23 | 23 | 7 | 71.00 | 6.00 | 7 | 13.00 | — | — | — | — | — | — | 10 |
| 24 | 24 | 7 | 71.00 | 6.00 | 8 | 13.00 | — | — | — | — | — | — | 10 |
| 25 | 25 | 7 | 71.00 | 6.00 | 9 | 13.00 | — | — | — | — | — | — | 10 |
| 26 | 26 | 7 | 71.00 | 6.00 | 10 | 13.00 | — | — | — | — | — | — | 10 |
| 27 | 27 | 7 | 71.00 | 6.00 | 11 | 13.00 | — | — | — | — | — | — | 10 |
| 28 | 28 | 8 | 71.00 | 6.00 | 11 | 13.00 | — | — | — | — | — | — | 10 |
| 29 | 29 | 9 | 71.00 | 6.00 | 11 | 13.00 | — | — | — | — | — | — | 10 |
| 30 | 30 | 10 | 71.00 | 6.00 | 11 | 13.00 | — | — | — | — | — | — | 10 |
| 31 | 31 | 10 | 71.00 | 6.00 | 11 | 13.00 | — | — | — | — | — | — | 10 |
| 32 | 32 | 11 | 71.00 | 6.00 | 11 | 13.00 | — | — | — | — | — | — | 10 |
| 33 | 33 | 12 | 71.00 | 6.00 | 11 | 13.00 | — | — | — | — | — | — | 10 |
| 34 | 34 | 13 | 71.00 | 6.00 | 11 | 13.00 | — | — | — | — | — | — | 10 |
| 35 | 35 | 11 | 83.00 | 6.00 | 11 | 1.00 | — | — | — | — | — | — | 10 |
| 36 | 36 | 14 | 71.00 | 6.00 | 11 | 13.00 | — | — | — | — | — | — | 10 |
| 37 | 37 | 15 | 71.00 | 6.00 | 1 | 13.00 | — | — | — | — | — | — | 10 |
| 38 | 38 | 16 | 71.00 | 6.00 | 1 | 13.00 | — | — | — | — | — | — | 10 |
| 39 | 39 | 21 | 74.00 | 6.00 | 1 | 10.00 | — | — | — | — | — | — | 10 |
| 40 | 40 | 17 | 74.00 | 6.00 | 1 | 10.00 | — | — | — | — | — | — | 10 |
| 41 | 41 | 18 | 74.00 | 6.00 | 1 | 10.00 | — | — | — | — | — | — | 10 |
| 42 | 42 | 19 | 74.00 | 6.00 | 1 | 10.00 | — | — | — | — | — | — | 10 |
| 43 | 43 | 1 | 67.00 | 6.00 | 1 | 17.00 | — | — | — | — | — | — | 10 |
| 44 | 44 | 7 | 71.00 | 6.00 | 17 | 13.00 | — | — | — | — | — | — | 10 |
| 45 | 45 | 20 | 71.00 | 6.00 | 11 | 13.00 | — | — | — | — | — | — | 10 |
| 46 | 46 | Amorphous resin 1 | 71.00 | 6.00 | 11 | 13.00 | — | — | — | — | — | — | 10 |
| 47 | 47 | 1 | 84.00 | 6.00 | — | 0.00 | — | — | — | — | — | — | 10 |

### Production Example of Toner 1

Toner particles 1: 100 parts
Inorganic fine particles 14: 1 part

The above materials were mixed in a Henschel mixer FM-10C (manufactured by Mitsui Miike Chemical Engineering Co., Ltd.) at a rotation speed of 50 s⁻¹ and a rotation time of 10 min to obtain toner 1. The physical properties are shown in Table 7.

### Production Examples of Toners 2 to 48

Toners 2 to 47 were produced in the same manner as in the production example of toner 1, except that the toner particles were changed to those shown in Table 6. Toner 48 was produced in the same manner as in the production example of toner 1, except that the inorganic fine particle 14 was changed to inorganic fine particle 15. The physical properties of the obtained toners 2 to 48 are shown in Table 7.

TABLE 7

| | | | | | Content of | Content A of | Content B of | |
|---|---|---|---|---|---|---|---|---|
| | Physical properties of toner | | | Difference in | inorganic fine | inorganic | inorganic | |
| | | Endothermic | Formula | number of | particles, toner | fine | fine | |
| Toner | D4 | peak top Tm | (1)/alkyl | carbon | particle | particles | particles | A/(A + |
| No. | μm | [° C.] | group | atoms | (% by mass) | (% by mass) | (% by mass) | B) × 100 |
| 1 | 6.1 | 60 | 133 | 4 | 10.00 | 9.9 | 0.10 | 99 |
| 2 | 6.1 | 60 | 133 | 2 | 10.00 | 9.8 | 0.20 | 98 |
| 3 | 6.1 | 60 | 133 | 4 | 10.00 | 9.6 | 0.40 | 96 |
| 4 | 6.1 | 60 | 133 | 2 | 10.00 | 9.9 | 0.10 | 99 |
| 5 | 6.1 | 45 | 133 | 2 | 10.00 | 9.7 | 0.30 | 97 |
| 6 | 6.1 | 65 | 133 | 6 | 10.00 | 9.2 | 0.80 | 92 |
| 7 | 6.1 | 60 | 133 | 6 | 10.00 | 9.3 | 0.70 | 93 |
| 8 | 6.1 | 60 | 1494 | 19 | 1.00 | 0.9 | 0.10 | 90 |
| 9 | 6.1 | 60 | 1494 | 21 | 1.00 | 0.9 | 0.10 | 90 |
| 10 | 6.1 | 60 | 1494 | 21 | 1.00 | 0.9 | 0.10 | 90 |
| 11 | 6.1 | 60 | 1494 | 21 | 1.00 | 0.9 | 0.10 | 90 |
| 12 | 6.1 | 60 | 133 | 21 | 1.00 | 0.9 | 0.10 | 90 |
| 13 | 6.1 | 60 | 1494 | 21 | 1.00 | 0.9 | 0.10 | 90 |
| 14 | 6.1 | 60 | 133 | 21 | 10.00 | 9.9 | 0.10 | 99 |
| 15 | 6.1 | 60 | 1971 | 21 | 0.76 | 0.7 | 0.06 | 92 |
| 16 | 6.1 | 60 | 7857 | 21 | 0.20 | 0.2 | 0.00 | 100 |
| 17 | 6.1 | 60 | 123 | 21 | 10.76 | 10.4 | 0.36 | 97 |
| 18 | 6.1 | 60 | 130 | 21 | 10.20 | 9.9 | 0.30 | 97 |
| 19 | 6.1 | 52 | 22 | 6 | 13.00 | 12.5 | 0.50 | 96 |
| 20 | 6.1 | 52 | 17 | 6 | 13.00 | 12.5 | 0.50 | 96 |
| 21 | 6.1 | 52 | 446 | 6 | 13.00 | 12.1 | 0.90 | 93 |
| 22 | 6.1 | 52 | 1338 | 6 | 13.00 | 12.2 | 0.80 | 94 |
| 23 | 6.1 | 52 | 14 | 6 | 13.00 | 12.5 | 0.50 | 96 |
| 24 | 6.1 | 52 | 12 | 6 | 13.00 | 12.5 | 0.50 | 96 |
| 25 | 6.1 | 52 | 12 | 6 | 13.00 | 12.4 | 0.60 | 95 |
| 26 | 6.1 | 52 | 12 | 6 | 13.00 | 12.5 | 0.50 | 96 |
| 27 | 6.1 | 52 | 17 | 6 | 13.00 | 12.5 | 0.50 | 96 |
| 28 | 6.1 | 50 | 13 | 6 | 13.00 | 12.7 | 0.30 | 98 |
| 29 | 6.1 | 52 | 13 | 6 | 13.00 | 12.5 | 0.50 | 96 |
| 30 | 6.1 | 52 | 13 | 6 | 13.00 | 12.4 | 0.60 | 95 |
| 31 | 6.1 | 52 | 13 | 6 | 13.00 | 12.3 | 0.70 | 95 |
| 32 | 6.1 | 52 | 11 | 6 | 13.00 | 12.5 | 0.50 | 96 |
| 33 | 6.1 | 52 | 30 | 6 | 13.00 | 12.2 | 0.80 | 94 |
| 34 | 6.1 | 52 | 32 | 6 | 13.00 | 12.5 | 0.50 | 96 |
| 35 | 6.1 | 52 | 11 | 6 | 1.00 | 0.0 | 1.00 | 0 |
| 36 | 6.1 | 50 | 5 | 6 | 13.00 | 12.8 | 0.20 | 98 |
| 37 | 6.1 | 80 | 98 | 12 | 13.00 | 12.4 | 0.60 | 95 |
| 38 | 6.1 | 60 | 88 | 4 | 13.00 | 12.6 | 0.40 | 97 |
| 39 | 6.1 | 60 | 133 | 4 | 10.00 | 9.8 | 0.20 | 98 |
| 40 | 6.1 | 59 | 133 | 4 | 10.00 | 9.8 | 0.20 | 98 |
| 41 | 6.1 | 39 | 133 | 4 | 10.00 | 9.6 | 0.40 | 96 |
| 42 | 6.1 | 84 | 133 | 14 | 10.00 | 9.6 | 0.40 | 96 |
| 43 | 6.1 | 60 | 71 | 4 | 17.00 | 17.0 | 0.00 | 100 |
| 44 | 6.1 | 52 | — | — | 13.00 | 12.5 | 0.50 | 96 |
| 45 | 6.1 | 50 | 3 | 6 | 13.00 | 12.4 | 0.60 | 95 |
| 46 | 6.1 | — | — | — | 13.00 | 12.6 | 0.40 | 97 |
| 47 | 6.1 | 60 | — | — | 0.00 | 0.0 | 0.00 | — |
| 48 | 6.1 | 60 | 133 | 4 | 10.00 | 9.9 | 0.10 | 99 |

In the table, formula (1)/alkyl group indicates the numerical value of [content (% by mass) of monomer unit represented by formula (1) based on the mass of toner particle]/[content (% by mass) of alkyl group on the surface of inorganic fine particles based on the mass of toner particle].

The difference in the number of carbon atoms indicates the difference between the number of carbon atoms of the alkyl group on the surface of the inorganic fine particle and the number of carbon atoms of R⁵ in formula (1).

In the table, “content of inorganic fine particles, toner particle” indicates the content (% by mass) of inorganic fine particles based on the mass of toner particle.

The content A of inorganic fine particles indicates the content A (% by mass) of inorganic fine particles in the region that is 0.3 μm or more inside from the surface of the toner particle. The content B of inorganic fine particles indicates the content B (% by mass) of inorganic fine particles present to a depth of 0.3 μm from the surface of the toner particle.

Where A/(A+B)×100(%) is 80 or more, inorganic fine particles are contained in the region that is 0.3 μm or more inside from the surface of the toner particle.

### Production Example of Magnetic Carrier 1

Magnetite 1 with a number-average particle diameter of 0.30 μm (magnetization strength of 65 Am²/kg in a magnetic field of 1000/4π (kA/m))
Magnetite 2 with a number average particle diameter of 0.50 m (magnetization strength of 65 Am²/kg in a magnetic field of 1000/4π (kA/m))

A total of 4.0 parts of a silane compound (3-(2-aminoethylaminopropyl)trimethoxysilane) was added to 100 parts of each of the above materials, and high-speed mixing and stirring were conducted at 100° C. or higher in a container to process respective fine particles.
Phenol: 10% by mass
Formaldehyde solution: 6% by mass (40% by mass of formaldehyde, 10% by mass of methanol, 50% by mass of water)
Magnetite 1 treated with the above silane compound: 58% by mass
Magnetite 2 treated with the above silane compound: 26% by mass

A total of 100 parts of the above materials, 5 parts of 28% by mass aqueous ammonia solution, and 20 parts of water were placed in a flask, the temperature was raised to 85° C. in 30 min while stirring and mixing, and the mixture was held for 3 h to polymerize and cure the resulting phenolic resin.

The cured phenolic resin was then cooled to 30° C., and water was further added, after which the supernatant liquid was removed, and the precipitate was washed with water and then air-dried. This was then dried under reduced pressure (5 mmHg or less) at a temperature of 60° C. to obtain magnetic body-dispersed spherical magnetic carrier 1. The 50% particle diameter (D50) based on volume of magnetic carrier 1 was 34.2 μm.

### Production Example of Two-Component Developer 1

A total of 8.0 parts of toner 1 was added to 92.0 parts of magnetic carrier 1 and mixed using a V-type mixer (V-20, manufactured by Seishin Enterprise Co., Ltd.) to obtain two-component developer 1.

### Production Examples of Two-Component Developers 2 to 48

Two-component developers 2 to 48 were produced in the same manner as in the production example of two-component developer 1, except for changing the toner as shown in Table 8.

TABLE 8

| Two-component developer | Toner No. | Carrier No. |
|---|---|---|
| Two-component developer 1 | 1 | 1 |
| Two-component developer 2 | 2 | 1 |
| Two-component developer 3 | 3 | 1 |
| Two-component developer 4 | 4 | 1 |
| Two-component developer 5 | 5 | 1 |
| Two-component developer 6 | 6 | 1 |
| Two-component developer 7 | 7 | 1 |
| Two-component developer 8 | 8 | 1 |
| Two-component developer 9 | 9 | 1 |
| Two-component developer 10 | 10 | 1 |
| Two-component developer 11 | 11 | 1 |
| Two-component developer 12 | 12 | 1 |
| Two-component developer 13 | 13 | 1 |
| Two-component developer 14 | 14 | 1 |
| Two-component developer 15 | 15 | 1 |
| Two-component developer 16 | 16 | 1 |
| Two-component developer 17 | 17 | 1 |
| Two-component developer 18 | 18 | 1 |
| Two-component developer 19 | 19 | 1 |
| Two-component developer 20 | 20 | 1 |
| Two-component developer 21 | 21 | 1 |
| Two-component developer 22 | 22 | 1 |
| Two-component developer 23 | 23 | 1 |
| Two-component developer 24 | 24 | 1 |
| Two-component developer 25 | 25 | 1 |
| Two-component developer 26 | 26 | 1 |
| Two-component developer 27 | 27 | 1 |
| Two-component developer 28 | 28 | 1 |
| Two-component developer 29 | 29 | 1 |
| Two-component developer 30 | 30 | 1 |
| Two-component developer 31 | 31 | 1 |
| Two-component developer 32 | 32 | 1 |
| Two-component developer 33 | 33 | 1 |
| Two-component developer 34 | 34 | 1 |
| Two-component developer 35 | 35 | 1 |
| Two-component developer 36 | 36 | 1 |
| Two-component developer 37 | 37 | 1 |
| Two-component developer 38 | 38 | 1 |
| Two-component developer 39 | 39 | 1 |
| Two-component developer 40 | 40 | 1 |
| Two-component developer 41 | 41 | 1 |
| Two-component developer 42 | 42 | 1 |
| Two-component developer 43 | 43 | 1 |
| Two-component developer 44 | 44 | 1 |
| Two-component developer 45 | 45 | 1 |
| Two-component developer 46 | 46 | 1 |
| Two-component developer 47 | 47 | 1 |
| Two-component developer 48 | 48 | 1 |

### Example 1

Evaluation was carried out using the two-component developer 1.

As an image forming device, a modified Canon digital commercial printer imageRUNNER ADVANCE C7770 was used, and two-component developer 1 was placed in a cyan developer unit. Modifications to the device included changes made to enable free setting of the fixing temperature, process speed, DC voltage VDC of the developer carrying member, charging voltage VD of the electrostatic latent image bearing member, and laser power. Image output evaluation was performed by outputting an FFh image (solid image) with the desired image ratio, adjusting VDC, VD, and laser power so that the toner laid-on level on the FFh image on the paper was as desired, and then performing the evaluation described below.

FFh is a value that expresses 256 gradations in hexadecimal, with 00h being the first gradation (white background) of the 256 gradations and FFh being the 256th gradation (solid area) of the 256 gradations.

The evaluation was performed based on the following evaluation method, and the results are shown in Table 12.

### Low-Temperature Fixability

Paper: GFC-081 (81.0 g/m²)

### (Sold by Canon Marketing Japan Inc.)

Toner laid-on level on paper: 0.70 mg/cm²
   (Adjusted by DC voltage VDC of developer carrying member, charging voltage VD of electrostatic latent image bearing member, and laser power)
Evaluation image: 2 cm×15 cm image placed in the center of the A4 paper
Test environment: low temperature and low humidity environment: temperature 15° C./humidity 10% RH (hereinafter “L/L”)
Fixing temperature: 100° C.
Process speed: 300 mm/sec

The evaluation image was output and low-temperature fixability was evaluated. The image density reduction rate was used as an evaluation index for low-temperature fixability.

The image density reduction rate was measured using the following procedure. First, the image density in the center was measured using an X-Rite color reflection densitometer (500 series: manufactured by X-Rite, Inc.). Next, a load of 4.9 kPa (50 g/cm²) was applied to the area where the image density had been measured, the fixed image was rubbed (10 times back and forth) with Silbon paper, and the image density was measured again.

The reduction rate of image density caused by rubbing was then calculated using the following formula. The resulting reduction rate of image density was evaluated according to the following evaluation criteria.

$$Image density reduction rate = ( image density before rubbing - image density after rubbing ) / ( image density before rubbing ) \times 100$$

### Evaluation Criteria

A: Image density reduction rate less than 2.0%
B: Image density reduction rate is 2.0% or more and less than 4.0%
C: Image density reduction rate is 4.0% or more and less than 6.0%
D: Image density reduction rate is 6.0% or more and less than 10.0%
E: Image density reduction rate is 10.0% or more

### Hot Offset Resistance

Paper: CS-064 (64.0 g/m²)

### (Sold by Canon Marketing Japan Inc.)

Toner laid-on level on paper: 0.08 mg/cm²
   (Adjusted by DC voltage VDC of developer carrying member, charging voltage VD of electrostatic latent image bearing member, and laser power)
Evaluation image: 2 cm×20 cm image was placed on the long edge of the A4 paper in the paper feed direction with a margin of 2 mm from the leading edge of the paper
Test environment: normal temperature and low humidity environment: temperature 23° C./humidity 5% RH (hereinafter “N/L”)
Fixing temperature: the temperature is raised from 100° C. to 130° C. in 10° C. increments, and from 130° C. in 1° C. increments
Process speed: 300 mm/sec

The above evaluation image was output, and hot offset resistance was evaluated according to the following criteria at the highest fixing temperature at which hot offset did not occur.

### Evaluation Criteria

A: 140° C. or higher
B: 135° C. or higher but less than 140° C.
C: 130° C. or higher but less than 135° C.
D: 120° C. or higher but less than 130° C.
E: 110° C. or higher but less than 120° C.
F: 100° C. or higher but less than 110° C.
G: Less than 100° C.

### Evaluation of Abrasion Resistance

Paper: Oce Top Coated Plus Silk 270 g (270.0 g/m²)
Toner laid-on level: 0.20 mg/cm²
Evaluation image: monochrome halftone image (5 cm×25 cm) placed on the A4 paper
Fixing test environment: normal temperature and normal humidity environment: temperature 23° C./humidity 50% RH
Process speed: 450 mm/sec
Fixing temperature: 150° C.

The image obtained under the above conditions was cut into strips and placed face up in the following device. Only paper was placed in the damper section, and a rubbing test was conducted under the following conditions.
Rubbing tester: Gakushin-type friction fastness tester (AB-301)
Weight: 500 g (0.5 kgf)
Stroke: 10 back-forth cycles

The toner was transferred to the rubbed paper (rubbing paper), and the L*, a*, and b* of the images of each gradation were measured for this rubbed paper and blank paper using a SpectroScan Transmission (manufactured by GretagMacbeth LLC) (measurement conditions: D50, viewing angle 2°). The ΔE calculated by the following formula was compared and used as an index for evaluating the abrasion resistance.

$$Δ E = ( rubbed paper ) {\{ {( {L}^{*} )}^{2} + {( {a}^{*} )}^{2} + {( {b}^{*} )}^{2} \}}^{0.5} - ( blank paper ) {\{ {( {L}^{*} )}^{2} + {( {a}^{*} )}^{2} + {( {b}^{*} )}^{2} \}}^{0.5}$$

The lower the ΔE, the better the abrasion resistance.

### Evaluation Criteria

A: ΔE is less than 4.0
B: ΔE is 4.0 or more and less than 7.0
C: ΔE is 7.0 or more and less than 10.0
D: ΔE is 10.0 or more

### Storage Stability

A total of 5 g of toner was placed in a 100 mL resin cup and allowed to stand in a temperature- and humidity-variable thermostatic chamber (50° C., 54%) for 72 h, after which the cohesiveness of the toner was evaluated. The cohesiveness was evaluated by the residual rate of the remaining toner when the toner was sifted through a 150 μm mesh with an amplitude of 0.5 mm for 10 sec using a Hosokawa Micron Powder Tester PT-X.

### Evaluation Criteria

A: Residual rate is less than 2.0%
B: Residual rate is 2.0% or more and less than 10.0%
   C: Residual rate is 10.0% or more

### Image Glossiness

Paper: GFC-081 (81.0 g/m²)

### (Sold by Canon Marketing Japan Inc.)

Toner laid-on level on paper: 0.40 mg/cm²
   (Adjusted by DC voltage VDC of developer carrying member, charging voltage VD of electrostatic latent image bearing member, and laser power)
Evaluation image: 2 cm×5 cm image placed in the center of the A4 paper
Test environment: temperature 23° C./humidity 50% RH
Fixing temperature: 160° C.
Process speed: 400 mm/sec

The evaluation image was output, and the image glossiness was evaluated. The image glossiness was evaluated by using a handheld gloss meter (“PG-1M”, manufactured by Tokyo Denshoku Co., Ltd.), measuring the value at a single angle of 60°, and using the measured value as the gloss value.

### Image Glossiness Evaluation Criteria

A: Gloss value is 10 or more
B: Gloss value is 5 or more and less than 10
C: Gloss value is less than 5

### Examples 2 to 40 and Comparative Examples 1 to 8

The evaluation was performed in the same manner as in Example 1, except that two-component developers 2 to 48 were used instead of two-component developer 1. The evaluation results are shown in Table 9.

TABLE 9

| | | Evaluation item | | | | | | | | | |
|---|---|---|---|---|---|---|---|---|---|---|---|
| | Two- | Low- | | | | | | | | | |
| | component | temperature | | Hot offset | | Abrasion | | Storage | | Image | |
| Example | developer | fixability | | resistance | | resistance | | stability | | glossiness | |
| No. | No. | % | Rank | ° C. | Rank | ΔE | Rank | % | Rank | — | Rank |
| 1 | 1 | 1.5 | A | 145 | A | 2.0 | A | 1.5 | A | 13 | A |
| 2 | 2 | 1.5 | A | 145 | A | 2.0 | A | 1.5 | A | 13 | A |
| 3 | 3 | 1.5 | A | 145 | A | 2.0 | A | 1.5 | A | 13 | A |
| 4 | 4 | 1.5 | A | 145 | A | 2.0 | A | 1.5 | A | 13 | A |
| 5 | 5 | 3.0 | B | 145 | A | 2.0 | A | 1.5 | A | 13 | A |
| 6 | 6 | 3.0 | B | 138 | B | 5.5 | B | 1.5 | A | 13 | A |
| 7 | 7 | 1.5 | A | 138 | B | 5.5 | B | 1.5 | A | 14 | A |
| 8 | 8 | 1.5 | A | 133 | C | 5.5 | B | 1.5 | A | 14 | A |
| 9 | 9 | 1.5 | A | 133 | C | 5.5 | B | 1.5 | A | 13 | A |
| 10 | 10 | 1.5 | A | 133 | C | 5.5 | B | 1.5 | A | 14 | A |
| 11 | 11 | 1.5 | A | 133 | C | 5.5 | B | 1.5 | A | 14 | A |
| 12 | 12 | 1.5 | A | 138 | B | 5.5 | B | 1.5 | A | 12 | A |
| 13 | 13 | 1.5 | A | 133 | C | 5.5 | B | 1.5 | A | 13 | A |
| 14 | 14 | 1.5 | A | 138 | B | 5.5 | B | 1.5 | A | 13 | A |
| 15 | 15 | 1.5 | A | 133 | C | 5.5 | B | 1.5 | A | 12 | A |
| 16 | 16 | 1.5 | A | 133 | C | 5.5 | B | 1.5 | A | 12 | A |
| 17 | 17 | 1.5 | A | 138 | B | 5.5 | B | 1.5 | A | 11 | A |
| 18 | 18 | 1.5 | A | 138 | B | 5.5 | B | 1.5 | A | 13 | A |
| 19 | 19 | 1.5 | A | 138 | B | 5.5 | B | 1.5 | A | 14 | A |
| 20 | 20 | 1.5 | A | 133 | C | 5.5 | B | 1.5 | A | 12 | A |
| 21 | 21 | 1.5 | A | 138 | B | 5.5 | B | 1.5 | A | 13 | A |
| 22 | 22 | 1.5 | A | 133 | C | 8.5 | C | 1.5 | A | 15 | A |
| 23 | 23 | 1.5 | A | 133 | C | 5.5 | B | 1.5 | A | 14 | A |
| 24 | 24 | 1.5 | A | 133 | C | 5.5 | B | 1.5 | A | 7 | B |
| 25 | 25 | 1.5 | A | 133 | C | 5.5 | B | 1.5 | A | 7 | B |
| 26 | 26 | 1.5 | A | 125 | D | 8.5 | C | 1.5 | A | 6 | B |
| 27 | 27 | 1.5 | A | 125 | D | 8.5 | C | 1.5 | A | 13 | A |
| 28 | 28 | 3.0 | B | 125 | D | 8.5 | C | 1.5 | A | 14 | A |
| 29 | 29 | 3.0 | B | 115 | E | 8.5 | C | 1.5 | A | 11 | A |
| 30 | 30 | 5.0 | C | 115 | E | 8.5 | C | 1.5 | A | 13 | A |
| 31 | 31 | 5.0 | C | 115 | E | 8.5 | C | 1.5 | A | 15 | A |
| 32 | 32 | 8.0 | D | 115 | E | 8.5 | C | 1.5 | A | 10 | A |
| 33 | 33 | 5.0 | C | 125 | D | 8.5 | C | 1.5 | A | 14 | A |
| 34 | 34 | 5.0 | C | 125 | D | 8.5 | C | 5.0 | B | 16 | A |
| 35 | 35 | 1.5 | A | 125 | D | 8.5 | C | 1.5 | A | 14 | A |
| 36 | 36 | 3.0 | B | 125 | D | 8.5 | C | 1.5 | A | 14 | A |
| 37 | 37 | 3.0 | B | 138 | B | 5.5 | B | 1.5 | A | 14 | A |
| 38 | 38 | 1.5 | A | 145 | A | 2.0 | A | 1.5 | A | 14 | A |
| 39 | 39 | 1.5 | A | 145 | A | 2.0 | A | 1.5 | A | 14 | A |
| 40 | 48 | 1.5 | A | 145 | A | 2.0 | A | 1.5 | A | 13 | A |
| C.E. 1 | 40 | 1.5 | A | 95 | G | 2.0 | A | 1.5 | A | 14 | A |
| C.E. 2 | 41 | 11.0 | E | 95 | G | 2.0 | A | 12.0 | C | 13 | A |
| C.E. 3 | 42 | 11.0 | E | 138 | B | 5.5 | B | 1.5 | A | 12 | A |
| C.E. 4 | 43 | 11.0 | E | 145 | A | 2.0 | A | 1.5 | A | 12 | A |
| C.E. 5 | 44 | 1.5 | A | 95 | G | 11.0 | D | 1.5 | A | 7 | B |
| C.E. 6 | 45 | 11.0 | E | 95 | G | 8.5 | C | 1.5 | A | 13 | A |
| C.E. 7 | 46 | 11.0 | E | 125 | D | 8.5 | C | 1.5 | A | 13 | A |
| C.E. 8 | 47 | 1.5 | A | 95 | G | 11.0 | D | 1.5 | A | 7 | B |

In the Table 9, “C.E.” indicates “Comparative example”.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-210572, filed Dec. 13, 2023, and Japanese Patent Application No. 2024-204019, filed Nov. 22, 2024, which are hereby incorporated by reference herein in their entirety.

What is claimed is:

1. A toner comprising a toner particle comprising a binder resin and an inorganic fine particle, wherein
the binder resin comprises a crystalline vinyl resin having a monomer unit represented by a following formula (1),
a content of the monomer unit represented by the following formula (1) is at least 5.0% by mass, based on a mass of the crystalline vinyl resin,
the inorganic fine particle has at a surface thereof an alkyl group, and
a content of the inorganic fine particle is 0.10 to 15.00% by mass, based on the mass of the toner particle: 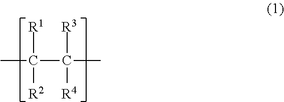
in formula (1), at least two of R¹ to R⁴ are each independently —X—COOR⁵, and the remaining are each independently a hydrogen atom or an alkyl group having 1 to 4 carbon atoms, X is a single bond or an alkylene group having 1 or 2 carbon atoms, and R⁵ is an alkyl group having 16 to 30 carbon atoms.

2. The toner according to claim 1, wherein, in cross-sectional observation of the toner with a transmission electron microscope, the toner particle comprises the inorganic fine particle in a region that is at least 0.3 μm inside from surface of the toner particle.

3. The toner according to claim 1, wherein a content of the crystalline vinyl resin is 30% by mass to 80% by mass, based on the mass of the binder resin.

4. The toner according to claim 1, wherein, in formula (1), at least two of R¹ to R⁴ are each independently —COOR⁵ (R⁵ is an alkyl group having 16 to 30 carbon atoms).

5. The toner according to claim 1, wherein, in the formula (1), either one of R¹ and R², and either one of R³ and R⁴ are each independently —COOR⁵ (R⁵ is an alkyl group having 16 to 30 carbon atoms).

6. The toner according to claim 1, wherein the content of the monomer unit represented by the formula (1) is at least 30.0% by mass, based on the mass of the crystalline vinyl resin.

7. The toner according to claim 1, wherein a number-average particle diameter of primary particles of the inorganic fine particle is 10 to 500 nm.

8. The toner according to claim 1, wherein a content of the alkyl group at the surface of the inorganic fine particle is 0.10% by mass to 5.00% by mass, based on the mass of the inorganic fine particle.

9. The toner according to claim 1, wherein the content (% by mass) of the monomer unit represented by the formula (1), based on the mass of the toner particle is at least 20 times a content (% by mass) of the alkyl group at the surface of the inorganic fine particle, based on the mass of the toner particle.

10. The toner according to claim 1, wherein difference between number of carbon atoms of the alkyl group at the surface of the inorganic fine particle and number of carbon atoms of R⁵ in the formula (1) is not more than 5.

11. The toner according to claim 1, wherein R⁵ in the formula (1) is a linear alkyl group having 18 carbon atoms or a linear alkyl group having 22 carbon atoms.

12. The toner according to claim 1, wherein the inorganic fine particle comprises calcium carbonate.

13. The toner according to claim 1, wherein the crystalline vinyl resin comprises at least one monomer unit selected from the group consisting of a monomer unit represented by a following formula (N) and a monomer unit represented by a following formula (H): 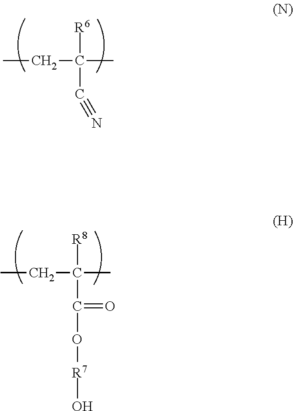
in formula (N), R⁶ is a hydrogen atom or a methyl group, and in formula (H), R⁷ is an alkylene group having 1 to 4 carbon atoms, and R⁸ is a hydrogen atom or a methyl group.
